(19) United States
(12) Patent Application Publication
(10) Pub. No.: US 2026/0343454 A1
(43) Pub. Date: Oct. 29, 2026

(54) METHODS AND APPARATUSES FOR MANAGING COORDINATED RESTRICTED TARGET WAKE TIME IN WIRELESS COMMUNICATION NETWORK

(71) Applicant: Samsung Electronics Co., Ltd., Suwon-si (KR)

(72) Inventors: Rishabh ROY, Bangalore (IN); Ankur BANSAL, Bangalore (IN); Karthik Srinivasa GOPALAN, Bangalore (IN); Aniruddh Rao KABBINALE, Bangalore (IN); Anand JEE, Bangalore (IN)

(21) Appl. No.: 19/656,422

(22) Filed: Apr. 23, 2026

Related U.S. Application Data
(63) Continuation of application No. PCT/KR2026/096160, filed on Apr. 22, 2026.

(30) Foreign Application Priority Data
Apr. 25, 2025 (IN) 202511040047
Mar. 18, 2026 (IN) 2025 11040047

(51) Int. Cl. H04W 56/00; H04B 7/06

(52) U.S. Cl. CPC H04W 56/0045; H04B 7/0617

(57) ABSTRACT

A method for managing coordinated restricted target wake time (Co-RTWT) by a requesting access point in a wireless communication network is provided. The method may comprise transmitting a Co-RTWT negotiation request message including information about restricted target wake time (RTWT) schedule protection level indicating at least one of coordinated beamforming (Co-BF) or coordinated spatial reuse (Co-SR) is usable for a RTWT schedule, to one or more coordinated access points; receiving a Co-RTWT negotiation response message including an indication of a selection of the Co-BF or the Co-SR based on the information about the RTWT schedule protection level; and establishing a Co-RTWT agreement for the RTWT schedule based on the selected Co-BF or Co-SR.

### CROSS-REFERENCE TO RELATED APPLICATION(S)

This application is a continuation application, claiming priority under 35 U.S.C. § 365 (c), of an International Application No. PCT/KR2026/096160, filed on Apr. 22, 2026, which is based on and claims the benefit of an Indian Provisional Patent Application No. 202511040047, filed on Apr. 25, 2025, in the Indian Patent Office, and of an Indian Complete patent application No. 202511040047, filed on Mar. 18, 2026, in the Indian Patent Office, the disclosure of each of which is incorporated by reference herein in its entirety.

### TECHNICAL FIELD

The disclosure relates to wireless communication systems. More particularly, the disclosure relates to methods and systems for managing coordinated restricted target wake time (Co-RTWT) in a wireless local area network.

### BACKGROUND

Wireless local area networks are widely deployed to provide data connectivity for a diverse set of devices and applications, including latency-sensitive services such as real-time communications, industrial control, augmented reality, and interactive multimedia. As device density and traffic demand increase, wireless local area network deployments frequently include multiple access points operating in overlapping coverage areas. In environments where coverage areas of different access points overlap, transmissions originating from one basic service set may interfere with transmissions of another basic service set. Such interference conditions may affect reliability, latency, throughput, and overall spectrum efficiency, particularly in dense deployments where multiple access points compete for channel access.

Wireless communication protocols support power-saving and scheduling mechanisms that allow stations to operate according to negotiated wake time schedules. Restricted Target Wake Time operation enables scheduled communication between an access point and one or more associated stations during defined service periods, which may be used to support deterministic or latency-sensitive traffic flows.

When multiple access points operate within mutual interference range, coordination procedures may be used to exchange information and establish agreements relating to usage. Such coordination may involve negotiation messages exchanged between access points that define operational parameters or behavioural constraints intended to improve coexistence performance across overlapping networks.

In certain coordinated operation scenarios, one access point may request protection for scheduled service periods associated with its stations so that transmissions occurring in neighbouring networks do not adversely affect scheduled communications. In dense network environments, accommodating such protection requests while maintaining efficient channel utilization across all participating networks presents operational challenges.

Wireless system implementations are typically subject to practical constraints including signaling overhead, processing capability, protocol complexity, and interoperability requirements. These considerations may influence how coordination procedures are structured and how information is exchanged between network entities while maintaining efficient use of wireless resources.

Accordingly, there is a need for techniques that facilitate coordinated operation among access points in wireless local area networks in a manner that supports reliable scheduled communications, efficient medium utilization, and practical implementation within protocol and device constraints.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages d described below. Accordingly, an aspect of the disclosure is to provide methods and systems for managing coordinated restricted target wake time (Co-RTWT) in a wireless local area network.

Additional aspects will be set forth in part in the description which follows and, in part, will be apparent from the description, or may be learned by practice of the presented embodiments.

In accordance with an aspect of the disclosure, a method for managing coordinated restricted target wake time (Co-RTWT) by a requesting access point in a wireless communication network is provided. The method comprises transmitting a Co-RTWT negotiation request message including information about restricted target wake time (RTWT) schedule protection level indicating at least one of coordinated beamforming (Co-BF) or coordinated spatial reuse (Co-SR) is usable for a RTWT schedule, to one or more coordinated access points; transmitting, receiving a Co-RTWT negotiation response message including an indication of a selection of the Co-BF or the Co-SR based on the information about the RTWT schedule protection level; and establishing a Co-RTWT agreement for the RTWT schedule based on the selected Co-BF or Co-SR.

In an embodiment, the information about the RTWT schedule protection level includes a parameter configured to indicate a coordination mode that determines whether transmission by the one or more coordinated access points is permitted and how the transmission is performed during a protected service period of the RTWT schedule.

In an embodiment, Co-RTWT negotiation request message includes restricted target wake time station information identifying one or more stations associated with the RTWT schedule.

In an embodiment, the method further comprises, including in the Co-RTWT negotiation request message a Co-BF scheme information set or a Co-SR scheme information set, and associating the Co-BF or Co-SR with a restricted target wake time schedule identifier.

In an embodiment, the method further comprises broadcasting an intra-basic service set announcement indicating the RTWT schedule and the selected Co-BF or Co-SR to its associated stations.

In accordance with an aspect of the disclosure, a method for managing coordinated restricted target wake time (Co-RTWT) in a wireless local area network is provided. The method includes transmitting by a requesting access point (AP), Co-RTWT negotiation request message including RTWT schedule protection level information to one or more coordinated APs, receiving by the requesting AP, Co-RTWT negotiation response message including RTWT schedule protection level information from one or more coordinated APs, transmitting by the requesting AP, a trigger frame to request Coordinated Beamforming information set (Co-BF) or Coordinated Spatial Reuse information set (Co-SR) based on RTWT schedule protection level information received to one or more coordinated APs, receiving by the requesting AP, Coordinated Beamforming information set (Co-BF) or Coordinated Spatial Reuse information set (Co-SR) from the one or more coordinated APs, and establishing by the requesting AP, Coordinated Beamforming (Co-BF) or Coordinated Spatial Reuse (Co-SR) scheme with one or more coordinated APs.

In accordance with an aspect of the disclosure, a method for managing coordinated restricted target wake time (Co-RTWT) in a wireless local area network is provided. The method comprises receiving a Co-RTWT negotiation request message from a requesting access point, the Co-RTWT negotiation request message including information about RTWT schedule protection level indicating at least one of coordinated beamforming (Co-BF) or a coordinated spatial reuse (Co-SR) is usable for a RTWT schedule; selecting the Co-BF or the Co-SR based on the information about the RTWT schedule protection level and coordinated transmission capabilities of the coordinated access point; transmitting a Co-RTWT negotiation response message including an indication of the selected Co-BF or Co-SR; and establishing a Co-RTWT agreement for the RTWT schedule based on the selected Co-BF or Co-SR.

In an embodiment, selecting the Co-BF or the Co-SR comprises evaluating antenna configuration and spatial stream capability of the coordinated access point.

In an embodiment, selecting the Co-BF or the Co-SR comprises evaluating transmit power control capability associated with the Co-SR.

In an embodiment, the method comprises associating at least one coordinated transmission parameter with a RTWT schedule identifier and RTWT station information.

In an embodiment, the at least one coordinated transmission parameter include at least one of spatial stream information, antenna configuration information, and transmit power information.

In an embodiment, the method involves performing Co-BF negotiation or Co-SR negotiation using an existing coordinated beamforming or coordinated spatial reuse negotiation procedure within a Co-RTWT negotiation.

In accordance with an aspect of the disclosure, a requesting access point for managing coordinated restricted target wake time (Co-RTWT) in a wireless communication network is provided. The requesting access point may comprise memory storing instructions and at least one processor coupled to the memory. The instructions, when executed by the at least one processor, individually or collectively, may cause the requesting access point to perform operations. The operations comprise transmitting a Co-RTWT negotiation request message including information about restricted target wake time (RTWT) schedule protection level indicating at least one of coordinated beamforming (Co-BF) or coordinated spatial reuse (Co-SR) is usable for a RTWT schedule, to one or more coordinated access points; receiving a Co-RTWT negotiation response message including an indication of a selection of the Co-BF or the

Co-SR based on the information about the RTWT schedule protection level; and establishing a Co-RTWT agreement for the RTWT schedule based on the selected Co-BF or Co-SR.

In accordance with an aspect of the disclosure, a method for managing coordinated restricted target wake time (Co-RTWT) in a wireless local area network is provided. The method includes receiving, by a coordinated access point, a Co-RTWT negotiation request message from a requesting access point, the Co-RTWT negotiation request message including RTWT schedule protection level information, transmitting, by the coordinated access point, a Co-RTWT negotiation response message including RTWT schedule protection level information to the requesting access point, receiving, by the coordinated access point, a trigger frame requesting a coordinated beamforming information set or a coordinated spatial reuse information set based on the RTWT schedule protection level, transmitting, by the coordinated access point, the coordinated beamforming information set or the coordinated spatial reuse information set to the requesting access point, and establishing, by the coordinated access point, a coordinated beamforming scheme or a coordinated spatial reuse scheme with the requesting access point.

In accordance with an aspect of the disclosure, a system for managing coordinated restricted target wake time (Co-RTWT) in a wireless local area network is provided. The system includes a requesting access point including one or more processors and memory storing instructions that, when executed individually or collectively, cause the requesting access point to transmit a Co-RTWT negotiation request message to one or more coordinated access points, the Co-RTWT negotiation request message including RTWT schedule protection level information, receive a Co-RTWT response message including an indication of a selection of coordinated beamforming or coordinated spatial reuse based on the RTWT schedule protection level information, and establish a Co-RTWT agreement for a restricted target wake time schedule based on the selected RTWT schedule protection level information, and a coordinated access point including one or more processors and memory storing instructions that, when executed individually or collectively, cause the coordinated access point to receive the Co-RTWT negotiation request message including the RTWT schedule protection level information, select coordinated beamforming or coordinated spatial reuse based on the RTWT schedule protection level information and coordinated transmission capabilities of the coordinated access point, transmit the Co-RTWT negotiation response message including an indication of the selected coordinated beamforming or coordinated spatial reuse, and establish the Co-RTWT agreement for the RTWT schedule based on the selected RTWT schedule protection level information.

In an embodiment, the system is configured to perform coordinated beamforming or coordinated spatial reuse negotiation after transmission of the Co-RTWT negotiation response message using one or more subsequent message exchanges between the requesting access point and the coordinated access point, or to perform coordinated beamforming or coordinated spatial reuse negotiation within the Co-RTWT negotiation request message and the Co-RTWT negotiation response message using one or more coordinated beamforming or coordinated spatial reuse information sets exchanged during Co-RTWT negotiation.

In an embodiment, RTWT schedule protection level information includes a parameter configured to indicate a coordination mode that governs whether transmission by the one or more coordinated access points is permitted and, when permitted, how the transmission is performed during a protected service period of the RTWT schedule.

In accordance with an aspect of the disclosure, one or more non-transitory computer-readable storage media storing one or more computer programs including computer-executable instructions that, when executed by one or more processors of a requesting access point individually or collectively, cause the requesting access point to perform operations are provided. The operations include transmitting a Co-RTWT negotiation request message including Restricted Target Wake Time (RTWT) schedule protection level information and Coordinated Beamforming scheme information set (Co-BF) or Coordinated Spatial Reuse scheme information set (Co-SR) to one or more coordinated access points, receiving a Co-RTWT negotiation response message including an indication of a selection of Co-BF or Co-SR based on RTWT schedule protection level, and establishing a Co-RTWT agreement for the RTWT schedule based on the selected RTWT schedule protection level information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a system environment in which embodiments of the disclosure may be practiced, according to an embodiment of the disclosure;

FIG. 2 illustrates an example block diagram of a system 200 that support management of Coordinated Restricted Target Wake Time (Co-RTWT) in a wireless local area network, according to an embodiment of the disclosure;

FIG. 3 illustrates a flow diagram of a method for managing Coordinated Restricted Target Wake Time (Co-RTWT) in a wireless local area network, the method being performed by a requesting access point, according to an embodiment of the disclosure;

FIG. 4 illustrates a flow diagram of a method for managing Coordinated Restricted Target Wake Time (Co-RTWT) in a wireless local area network, the method being performed by coordinated access points, according to an embodiment of the disclosure;

FIG. 5 illustrates a sequence flow of a method for managing Coordinated Restricted Target Wake Time (Co-RTWT) in a wireless local area network, wherein coordinated beamforming or coordinated spatial reuse negotiation and agreement formation are performed jointly as part of a Co-RTWT negotiation, according to an embodiment of the disclosure;

FIG. 6 illustrates a flow diagram of a method for managing Coordinated Restricted Target Wake Time (Co-RTWT) in a wireless local area network, the method being performed by a requesting access point, according to an embodiment of the disclosure;

FIG. 7 illustrates a flow diagram of a method for managing Coordinated Restricted Target Wake Time (Co-RTWT) in a wireless local area network, the method being performed by coordinated access points, according to an embodiment of the disclosure;

FIG. 8 illustrates a sequence flow of a method for managing Coordinated Restricted Target Wake Time (Co-RTWT) in a wireless local area network, wherein coordinated beamforming negotiation or coordinated spatial reuse negotiation and agreement formation that are required as part of a Co-RTWT negotiation are performed separately, according to an embodiment of the disclosure;

FIG. 9 depicts a Multi-Access Point Coordination (MAPC) Element Information Element (IE) format used for managing Coordinated Restricted Target Wake Time (Co-RTWT) in a wireless local area network, the MAPC Element IE format including fields for carrying scheme-specific information associated with Co-RTWT negotiation, according to an embodiment of the disclosure;

FIG. 10 depicts a Co-RTWT Scheme sub-element Information Element (IE) format configured to carry RTWT schedule protection level information and related parameters for establishment of a Co-RTWT agreement for a RTWT schedule, according to an embodiment of the disclosure;

FIG. 11 depicts Information Elements configured to enable RTWT schedule protection as part of a Co-RTWT negotiation, the Information Elements including RTWT schedule protection level information and associated fields for indicating coordination mode during a protected service period of the RTWT schedule, according to an embodiment of the disclosure;

FIG. 12 depicts a RTWT Schedule Protection Level Info field format configured to indicate a coordination mode that determines whether transmission by one or more coordinated access points is permitted and how the transmission is performed during a protected service period of a RTWT schedule, according to an embodiment of the disclosure;

FIG. 13 depicts a Coordinated Beamforming scheme sub-element Information Element (Co-BF Scheme sub-element IE) format configured to carry a Coordinated Beamforming scheme information set (Co-BF) for use in a Co-RTWT negotiation and establishment of a Co-RTWT agreement for a RTWT schedule, according to an embodiment of the disclosure; and

FIG. 14 depicts a Coordinated Spatial Reuse scheme sub-element Information Element (Co-SR Scheme sub-element IE) format configured to carry a Coordinated Spatial Reuse scheme information set (Co-SR) for use in a Co-RTWT negotiation and establishment of a Co-RTWT agreement for a RTWT schedule, according to an embodiment of the disclosure.

The same reference numerals are used to represent the same elements throughout the drawings.

### OVERVIEW

To enable Coordinated Beamforming (Co-BF) and Coordinated Spatial Reuse (CSR) for Coordinated Restricted Target Wake Time (RTWT) Negotiation and Operation in a WLAN system, a Multi-Access Point Coordination (MAPC) framework is essential. The MAPC allows access points (APs) to share resources and negotiate transmissions in a coordinated manner, enhancing network performance and efficiency. The MAPC is discussed in IEEE 802.11bn Task Group (TG) where an AP forms coordination with an Overlapping Basic Service Set (OBSS) AP to efficiently share the wireless medium and other wireless resources e.g., time, space, transmit power, between them for interference mitigation, better medium utilization, increased reliability and improved latency. The MAPC framework introduces a set of multi-AP coordination schemes such as Coordinated Beamforming (Co-BF), Coordinated Spatial Reuse (Co-SR), Coordinated Time Division Multiple Access (Co-TDMA) and Coordinated Restricted Target Wake Time (Co-RTWT). An AP can establish coordination for one or more coordination scheme(s) with an OBSS AP which supports the same set of coordination scheme(s) via MAPC Discovery and MAPC Negotiation procedures defined in IEEE 802.11 TGbn.

Further, the Coordinated Restricted Target Wake Time (Co-RTWT) is being discussed in IEEE 802.11bn Task Group where an AP requests for protection for one or more of its RTWT schedule(s) to an Overlapping Basic Service Set (OBSS) AP where the latter extends protection for one or more of the requested RTWT schedule(s). In other words, the Co-RTWT is a wireless-fidelity (Wi-Fi) technology, that builds upon the Restricted Target Wake Time (RTWT) mechanism found in Wi-Fi 7 (IEEE 802.11be) and Target Wake Time (TWT) mechanism found in Wi-Fi 6 (IEEE 802.11ax). It enhances network efficiency and quality of service by allowing access points (APs) to coordinate the wake times of multiple stations (STAs) within a multi-AP environment. This coordination helps reduce contention and interference, leading to more predictable latency and improved performance for real-time applications.

An AP that requests for protection for its RTWT schedule(s) is called a Co-RTWT Requesting AP. An OBSS AP that extends protection for one or more of the RTWT schedule(s) requested by a Co-RTWT Requesting AP is called a Co-RTWT Coordinated AP. Via Co-RTWT negotiation, a Co-RTWT requesting AP and a Co-RTWT Coordinated AP establish a Co-RTWT agreement corresponding to a requested RTWT schedule.

The Co-RTWT negotiation procedure is part of IEEE 802.11bn Multi-AP Coordination (MAPC) negotiation where

the Co-RTWT requesting AP includes a Co-RTWT scheme sub-element in the Negotiation MAPC element transmitted in an individually addressed MAPC Negotiation Request frame to an OBSS AP that supports Co-RTWT.

The Co-RTWT scheme sub-element includes one or more MAPC Scheme Information field(s) where each contains Co-RTWT parameters corresponding to an requested RTWT schedule that requires protection.

The Co-RTWT coordinated AP responds to accept or reject the protection request via an individually addressed MAPC Negotiation Response frame.

Further, the Coordinated Beamforming (Co-BF) and Coordinated Spatial Reuse (Co-SR) are being discussed in IEEE 802.11 TGbn as multi-AP schemes which enable simultaneous transmissions by coordinating among two or more OBSS APs to increase medium utilization. The Co-BF enables coordination between two APs with multiple antennas where each AP beamforms to the negotiated STAs associated with it. On the other hand, the Co-SR enables coordination among multiple APs by controlling transmit power while transmitting to the negotiated STAs associated with it. Through coordinated simultaneous transmissions, both Co-BF and Co-SR increases medium utilization, mitigates interference and increases reliability of transmission.

In IEEE 802.11 TGbn, Co-BF and Co-SR negotiation procedures are defined similar to Co-RTWT negotiation where MAPC Negotiation Request and Response frame corresponding to each MAPC scheme contain respective scheme sub-elements inside MAPC element. A Co-BF scheme sub-element inside a MAPC element contains parameters related to a Co-BF agreement. The Co-SR scheme sub-element inside a MAPC element contains parameters related to a Co-SR agreement.

As per IEEE 802.11 TGbn, protection rules for Co-RTWT where an AP if extends protection of the RTWT schedule(s) of another AP through negotiation or other means, then

The AP shall ensure its TXOP ends before the start time of the corresponding OBSS rTWT Service Periods (SPs).

The AP, if it has at least one associated STA that is capable of rTWT, shall advertise in the beacon frames it transmits the OBSS rTWT schedule so that its associated STAs supporting rTWT follow the baseline rTWT rules for the OBSS rTWT schedule.

However, in the current protection rule, an AP that agrees to protect RTWT schedule(s) of another AP loses channel access in turn loses transmission opportunities for the entire duration of RTWT Service Periods (SPs). This decreases medium utilization efficiency. If an AP does not agree to protect the RTWT schedule(s) requested by an OBSS AP, then uncoordinated simultaneous transmissions in two BSSs causes a lot of interference to the latency-sensitive traffic flows during RTWT SPs which in turn deteriorates performance. Incentivisation in Co-RTWT feature is currently missing for the AP that is providing protection. Currently, there is no incentive for the AP extending protection to do so as it is losing channel access for the duration. Thus, there is a need to bring schemes to incentivize protection for Co-RTWT.

The disclosure describes a mechanism that allows coordinated access points to perform transmissions during a protected service period of a Coordinated Restricted Target Wake Time (Co-RTWT) schedule while maintaining protection for latency-sensitive traffic associated with the requesting access point. During a Co-RTWT negotiation, the requesting access point and one or more coordinated access points negotiate a protection mechanism corresponding to a coordination mode indicated by RTWT schedule protection level information. In some embodiments, the coordination mode may enable coordinated beamforming (Co-BF) or coordinated spatial reuse (Co-SR) during the Co-RTWT service period. By enabling Co-BF or Co-SR, the coordinated access point may perform transmissions in its basic service set while applying coordinated transmission parameters that reduce interference with the RTWT transmissions of the requesting access point.

Accordingly, the coordinated access point is able to continue serving its associated stations during the protected RTWT service period while ensuring that latency-sensitive RTWT transmissions in the requesting access point's basic service set are protected from interference. The disclosure therefore describes procedures and signaling mechanisms through which Co-BF or Co-SR negotiation may be performed as part of a Co-RTWT negotiation, including the exchange of scheme information sets and parameters required to establish coordinated transmission behavior between access points.

Thus, current Co-RTWT negotiation restricts the Co-RTWT coordinated AP from continuing its ongoing frame transmission if it has any exchanges in the BSS. The ongoing transmission may be important due to its time-sensitive nature and the coordinated AP may want to continue to use the channel instead of deferring its transmission and stay idle for the entire duration of the Co-RTWT SP. The proposed scheme improves the chance of negotiation success in Co-RTWT through incentivisation. Currently, there is no incentive for the AP extending protection to do so as it is losing channel access for the duration of the Co-RTWT SP. As per the proposed scheme, the AP extending protection may continue its transmission by sharing time (Co-TDMA), frequency (coordinated non-primary channel access (Co-NPCA)) or spatial resources (Co-SR/Co-BF) with the Co-RTWT requesting AP.

The disclosure describes a method to enable Co-BF and Co-SR as part of Co-RTWT agreement. The protection levels for Co-RTWT operation to add Co-BF/Co-SR as part of Co-RTWT negotiation procedure. The disclosure discloses a sequence of exchanges/operation to enable Co-BF and Co-SR incentivising extension of protection in a Co-RTWT negotiation. Further, the disclosure focuses to reuse the existing Co-BF and Co-SR procedure as part of Co-RTWT agreement. Further, the disclosure describes that IEs and messages to be exchanged between APs and between AP to STAs to enable Co-BF and Co-SR as part of Co-RTWT.

The protection levels and device nomenclature are disclosed below:

Device Nomenclature: The access point which is requesting for a negotiation is called Co-RTWT requesting/coordinating access point and the responding access points are called “Co-RTWT coordinated/responding access point.”

Protection levels: The protection levels for Co-RTWT operation in addition to the current protection mechanism which is to extend protection for the entire duration of a RTWT schedule(s)

Enable Co-BF agreement as part of extending protection to a requested RTWT schedule

Enable Co-SR agreement as part of extending protection to a requested

RTWT schedule

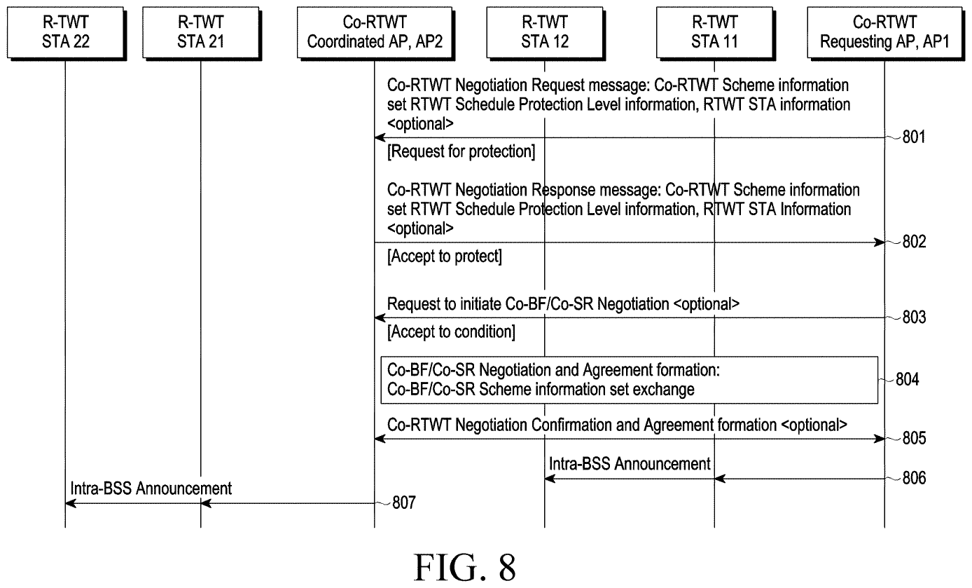

The disclosure describes an embodiment to enable Co-BF/Co-SR as part of Co-RTWT negotiation i.e., Co-BF/Co-SR negotiation embedded as shown in FIG. 8.

In this embodiment, Co-BF/Co-SR negotiation and agreement formation that is required as a part of the Co-RTWT negotiation is performed separately i.e., the message exchanges required for Co-BF/Co-SR negotiation is performed independently and in a successive manner after the Co-RTWT negotiation is initiated. Some parameter exchanges required for Co-BF/Co-SR negotiation e.g., STA Information is optionally exchanged along with Co-RTWT parameter exchanges during the Co-RTWT negotiation phase. The Co-RTWT requesting AP optionally includes the supported modes of protection mechanism, RTWT Schedule Protection Level Information for its requested RTWT schedule(s) in the Co-RTWT Negotiation Request frame and the Co-RTWT responding AP can select the suitable mode (enable Co-BF/Co-SR) supported by it in the Co-RTWT Negotiation Response frame. The final Co-RTWT Negotiation confirmation and agreement formation takes place after both the APs successfully complete the Co-BF/Co-SR negotiation and agreement formation after which an optional confirmation and agreement formation message exchange is performed between the APs. The APs exchange required parameters for Co-BF/Co-SR e.g., no. of Spatial Streams (SS), no. of Tx/Rx antenna, transmit power etc. during Co-BF/Co-SR negotiation. After the Co-RTWT negotiation is completed, The Co-RTWT requesting and coordinated AP broadcasts the negotiated RTWT schedule(s) and its related parameters and the negotiated protection mechanism to its associated STAs as an intra-BSS announcement which marks the end of Co-RTWT Negotiation phase.

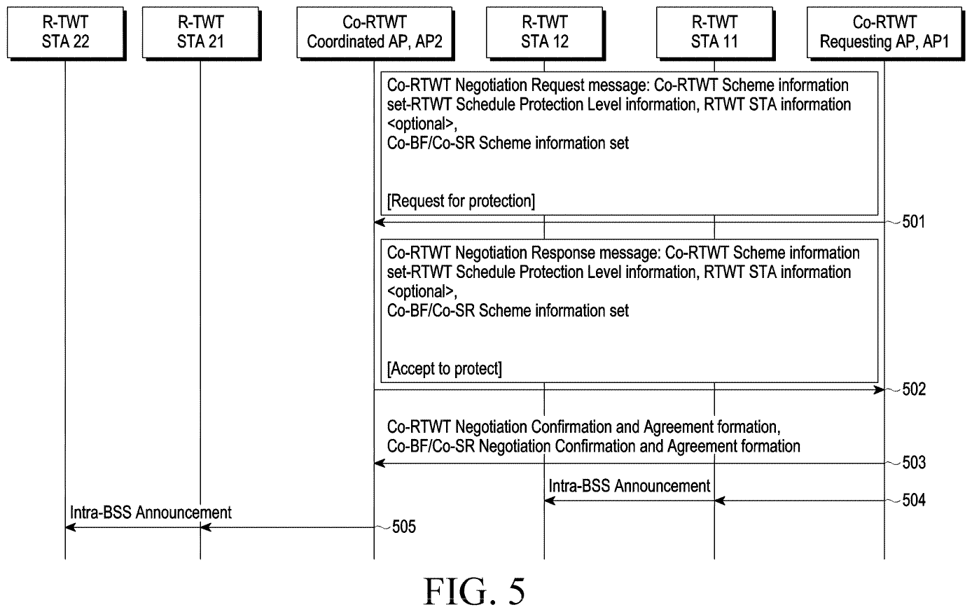

The disclosure describes an embodiment to enable Co-BF/Co-SR as part of Co-RTWT negotiation i.e., Joint Co-BF/CO-SR and Co-RTWT negotiation as shown in FIG. 5.

In this embodiment, the Co-BF/Co-SR negotiation and agreement formation that is required as a part of the Co-RTWT negotiation is performed jointly i.e., the message exchanges for Co-RTWT negotiation may contain Co-BF/Co-SR Scheme Information set(s) required for Co-BF/Co-SR negotiation along with Co-RTWT Scheme Information Set. The parameter required for Co-BF/Co-SR negotiation e.g., RTWT STA Information, other Co-BF/Co-SR Scheme Information set (e.g., No. of Spatial Streams, No. of Tx/Rx antenna, etc.) are exchanged along with Co-RTWT Scheme Information set exchanges during the Co-RTWT negotiation phase. Further, the Co-RTWT negotiation request frame contains Co-RTWT Scheme Information set, Co-BF/Co-SR Scheme Information set required for the Co-RTWT negotiation. The Co-RTWT requesting AP optionally includes the supported modes of protection mechanism for its requested RTWT schedule(s) in the Co-RTWT Negotiation Request frame. The Co-RTWT responding AP selects the suitable mode of RTWT protection (enable Co-BF/Co-SR) supported by it in the Co-RTWT Negotiation Response frame along with Co-BF/Co-SR Scheme Information set required for the Co-RTWT negotiation. The final Co-RTWT Negotiation confirmation and agreement formation takes place after both the APs successfully complete the Co-BF/Co-SR negotiation and agreement formation. After the Co-RTWT negotiation is completed, The Co-RTWT requesting and coordinated AP broadcasts the negotiated RTWT schedule(s) and its related parameters and the negotiated protection mechanism to its associated STAs as an intra-BSS announcement which marks the end of Co-RTWT Negotiation phase.

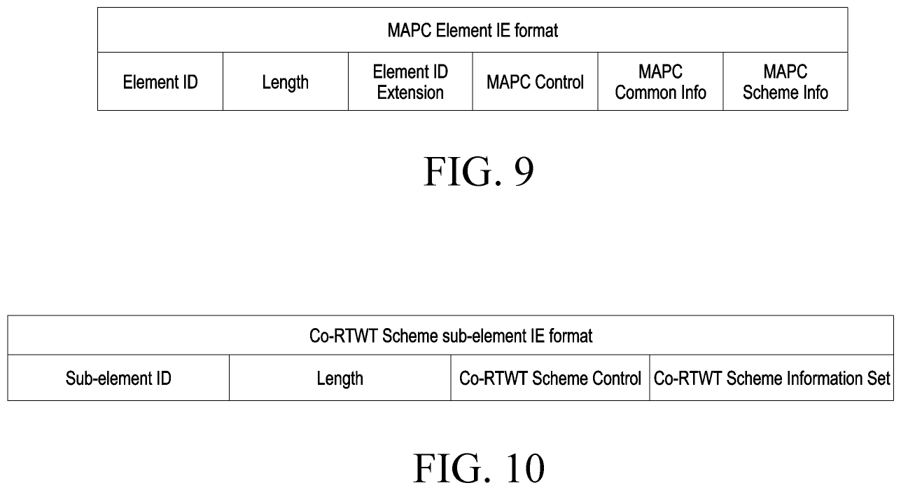

Further, the MAPC Negotiation Request frame and The MAPC Negotiation Response frame contain MAPC Negotiation Info field which carries a Negotiation MAPC Element IE as shown in FIG. 9. The MAPC Scheme Info field is present in a Negotiation MAPC Element which contains one or more sub-elements each corresponding to a MAPC scheme e.g., Co-RTWT Scheme sub-element, Co-BF Scheme sub-element etc. Further, the Co-RTWT Scheme sub-element contains parameters required for a Co-RTWT negotiation as shown in FIG. 10.

In some embodiments, additional Co-RTWT Negotiation Info Present field is set to 1 if the RTWT Schedule Protection Level Info field is present in the Co-RTWT Scheme Information Set field, and it is set to 0 otherwise. The MAPC Scheme ID is set to 3 to indicate the present sub-element is identified as a Co-RTWT scheme sub-element. RTWT STA Info to be passed along with these IEs optionally when indicating support or enabling various protection levels as part of “RTWT Schedule Protection Level Info” as shown in figure Tables 1 and 2 below.

TABLE 1
RTWT Schedule Protection Level Info

| Bit 0 | Bit 1 | Bit 2 | Bit 3 | Bit 4 | Bit 5-7 |
|---|---|---|---|---|---|
| Enable/ | Enable/ | Enable/ | Enable/ | Enable/ | Reserved |
| Support Full | Support | Support | Support | Support | |
| Protection | Co-BF | Co-SR | Co-TDMA | Co-NPCA | |

TABLE 2
RTWT Schedule Protection Level Info

| Bit 0-2 | | |
|---|---|---|
| Value | Meaning | Bit 3-7 |
| 0 | Enable/Support Full | Reserved |
| | Protection | |
| 1 | Enable/Support Co-BF | |
| 2 | Enable/Support Co-SR | |
| 3 | Enable/Support Co- | |
| | TDMA | |
| 4 | Enable/Support Co- | |
| | NPCA | |
| 5-7 | Reserved | |

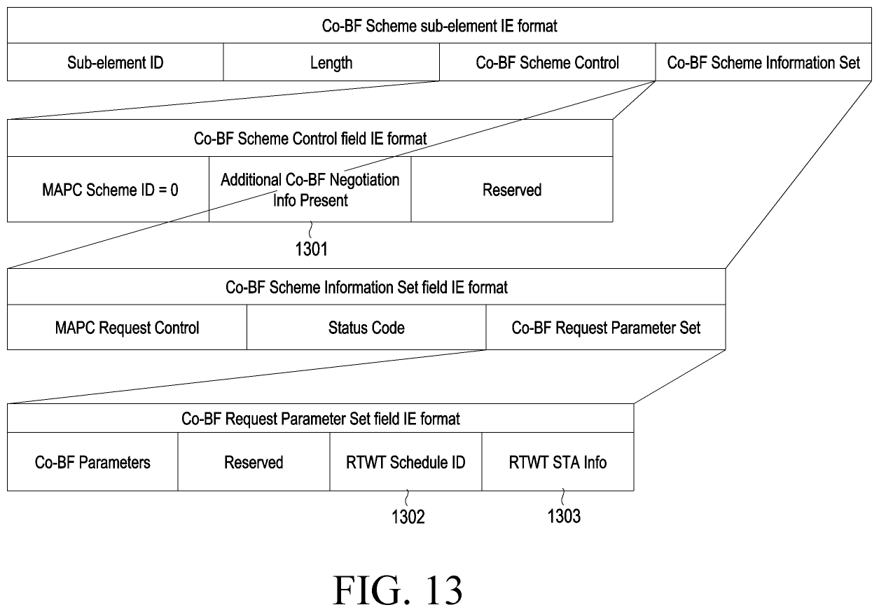

As described in FIG. 13, a Co-BF Scheme sub-element contains parameters required for a Co-BF negotiation. Additional Co-BF Negotiation Info Present field is set to 1 if the RTWT Schedule identifier (ID) and RTWT STA Info field are present in the Co-BF Scheme Information Set field, and it is set to 0 otherwise. The MAPC Scheme ID is set to 0 to indicate the present sub-element is identified as a Co-BF scheme sub-element. The RTWT Schedule ID denotes the Broadcast TWT ID field of the Restricted TWT Parameter Set field corresponding to the RTWT schedule that requires protection. The RTWT STA Info denotes Information related to RTWT STAs of a RTWT Schedule ID that needs protection.

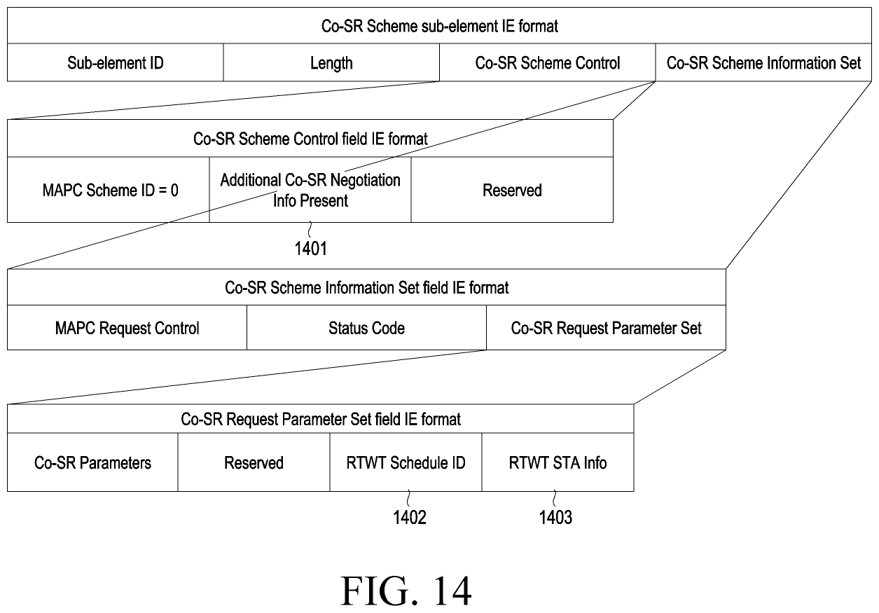

As described in FIG. 14, in an alternative embodiment, a Co-SR Scheme sub-element contains parameters required for a Co-SR negotiation. Additional Co-SR Negotiation Info Present field is set to 1 if the RTWT Schedule ID and RTWT STA Info field are present in the Co-SR Scheme Information Set field, and it is set to 0 otherwise. Further, the MAPC Scheme ID is set to 1 to indicate the present sub-element is identified as a Co-SR scheme sub-element. The RTWT Schedule ID denotes the Broadcast TWT ID field of the Restricted TWT Parameter Set field corresponding to the RTWT schedule that requires protection. Further, the RTWT STA Info denotes Information related to RTWT STAs of a RTWT Schedule ID that needs protection.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the document, the word “exemplary” is used herein to mean “serving as an example, instance, or illustration.” Any embodiment or implementation of the subject matter described herein as “exemplary” is not necessarily to be construed as preferred or advantageous over other embodiments.

The terms “comprises,” “comprising,” or any other variations thereof, are intended to cover a non-exclusive inclusion, such that a setup, device or method that comprises a list of components or operations does not include only those components or operations but may include other components or operations not expressly listed or inherent to such setup or device or method. In other words, one or more elements in a device or system or apparatus proceeded by “comprises . . . a” does not, without more constraints, preclude the existence of other elements or additional elements in the device or system or apparatus.

It may be noted that, for convenience of explanation, the disclosure uses terminology, message names, fields, parameters, and operational procedures consistent with those defined in wireless local area network standards, including specifications relating to medium access control coordination, multi-access point communication, and scheduled communication operation. More specifically, terms such as access point (AP), basic service set (BSS), overlapping basic service set (OBSS), station (STA), Restricted Target Wake Time (RTWT), service period (SP), transmission opportunity (TXOP), coordinated access point, requesting access point (also referred to as requesting AP), coordinated beamforming (Co-BF), coordinated spatial reuse (Co-SR), coordinated time division multiple access (Co-TDMA), coordinated non-primary channel access (Co-NPCA), Multi-AP Coordination (MAPC), negotiation request frame, negotiation response frame, scheme sub-element, information element (IE), schedule identifier, spatial streams, antenna configuration, and transmit power parameters are to be interpreted in accordance with the relevant wireless communication technical specifications.

In the context of the disclosure, an access point that transmits a negotiation request for coordinated restricted target wake time operation is referred to as a Co-RTWT requesting or coordinating access point, and one or more access points that receive and respond to the negotiation request are referred to as Co-RTWT coordinated access point also referred to as responding access points.

Unless otherwise stated, the use of such terminology in the disclosure is intended to be consistent with meanings and operational behaviour defined by applicable wireless networking standards and is provided solely to facilitate understanding of the described embodiments, without limiting the scope of the disclosure or implying restriction to any particular protocol release, draft specification, or implementation profile.

Disclosed herein are methods, access points, and systems for managing Coordinated Restricted Target Wake Time (Co-RTWT) operation in a wireless local area network. In wireless environments having multiple access points operating in overlapping coverage regions, scheduled communication mechanisms such as restricted target wake time may be used to support latency-sensitive traffic associated with one or more stations. During such operation, an access point may request protection for a scheduled service period so that transmissions from neighbouring access points do not interfere with scheduled communications. However, conventional coordination approaches may limit the ability of a responding access point to utilize wireless resources during such protected periods, which may reduce channel utilization efficiency and affect overall network performance. These limitations may restrict flexibility in coordinating transmissions among access points and may affect how coordination agreements are established or implemented in multi-access point environments. The disclosure addresses these considerations by enabling an access point to transmit a negotiation request including restricted target wake time schedule protection level information and coordinated transmission scheme information, receive a response indicating selection of a coordinated transmission mode, and establish a coordinated restricted target wake time agreement based on the selected protection level, thereby supporting coordinated operation among access points during scheduled service periods.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

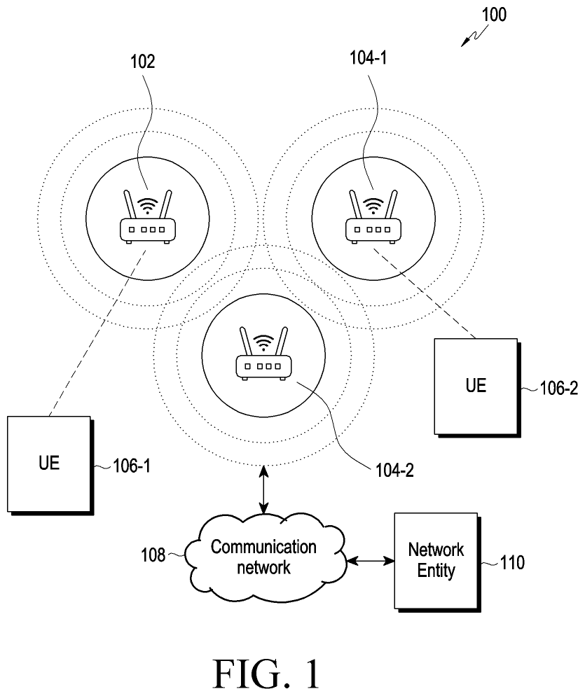

FIG. 1 illustrates an example system environment 100, which may also be referred to as a wireless local area network environment 100, according to an embodiment of the disclosure. The environment 100 may include a requesting access point 102, one or more coordinated access points such as coordinated AP-1 104-1 and coordinated AP-2 104-2, one or more user equipment devices including user equipment (UE) 106-1 associated with the requesting access point 102 and UE 106-2 associated with coordinated AP-1 104-1, a communication network 108, and a network entity 110. The requesting access point 102 and the coordinated access points 104-1 to 104-2 may operate in partially overlapping coverage regions and may be configured to exchange a Co-RTWT negotiation request message and a Co-RTWT negotiation response message through the communication network 108.

The user equipment devices 106-1 and 106-2 may include wireless client devices capable of communicating with an access point in a wireless local area network. In the context of wireless local area networks, such user equipment may also be referred to as a station (STA). For example, the user equipment may include a smartphone, a laptop, an Internet of Things (IoT) sensor device, a wearable device, a tablet, an industrial wireless device, or any other Wi-Fi enabled client device associated with an access point. Such user equipment may be capable of operating according to Restricted Target Wake Time (RTWT) schedules established by the requesting access point and may communicate with the requesting access point or with a coordinated access point during scheduled service periods of the RTWT schedule.

The requesting access point 102 may communicate with one or more associated user equipment devices, such as UE 106-1, according to a RTWT schedule. The requesting access point 102 may transmit a Co-RTWT negotiation request message to one or more coordinated access points including coordinated AP-1 104-1 and coordinated AP-2 104-2. The Co-RTWT negotiation request message may include RTWT schedule protection level information and may optionally include a Coordinated Beamforming scheme information set (Co-BF) or a Coordinated Spatial Reuse scheme information set (Co-SR) that may indicate coordinated transmission behaviour during a protected service period of the RTWT schedule.

Each coordinated access point, such as coordinated AP-1 104-1 or coordinated AP-2 104-2, may be configured to receive the Co-RTWT negotiation request message and may evaluate the RTWT schedule protection level information. Based on this evaluation, the coordinated access point may select coordinated beamforming or coordinated spatial reuse according to coordinated transmission capabilities of the coordinated access point. Such coordinated transmission capabilities may include, for example, antenna configuration capability, spatial stream capability, transmit power capability, or other coordinated transmission parameters that may be used to determine whether coordinated beamforming or coordinated spatial reuse may be supported.

The user equipment devices 106-1 and 106-2 may communicate with their respective access points according to RTWT schedules. For example, UE 106-1 may communicate with the requesting access point 102 during service periods of the RTWT schedule, while UE 106-2 may communicate with coordinated AP-1 104-1 using transmissions that may correspond to coordinated beamforming or coordinated spatial reuse during service periods of the RTWT schedule established through a Co-RTWT agreement.

The communication network 108 may include one or more wired or wireless communication links that may enable signaling exchange between the requesting access point 102, the coordinated access points 104-1 to 104-n, and the network entity 110. In some embodiments, the communication network 108 may support exchange of the Co-RTWT negotiation request message, the Co-RTWT negotiation response message, a trigger frame, or a coordinated beamforming information set or coordinated spatial reuse information set between the requesting access point 102 and the coordinated access points.

In some embodiments, the trigger frame may represent a control frame that may be transmitted by the requesting access point to request or initiate coordinated transmission negotiation procedures with one or more coordinated access points. The trigger frame may carry parameters associated with coordinated beamforming negotiation or coordinated spatial reuse negotiation and may be transmitted after exchange of the Co-RTWT negotiation request message and the Co-RTWT negotiation response message. In other implementations, the trigger functionality may be implemented through any suitable signaling message, management frame, or control frame capable of initiating coordinated transmission negotiation between access points.

The network entity 110 may include a controller, management node, or coordination function that may support operation of the requesting access point 102 or the coordinated access points 104-1 to 104-2. In some embodiments, the network entity 110 may store configuration parameters, coordinated transmission parameters, or policy information that may be associated with establishment of a Co-RTWT agreement for a RTWT schedule.

During operation, the requesting access point 102 may transmit the Co-RTWT negotiation request message to one or more coordinated access points in order to establish a Co-RTWT agreement for a RTWT schedule. The coordinated access points may transmit a Co-RTWT negotiation response message indicating selection of coordinated beamforming or coordinated spatial reuse based on the RTWT schedule protection level information. Based on the exchanged signaling messages, the requesting access point 102 and the coordinated access points may establish the Co-RTWT agreement so that transmissions corresponding to coordinated beamforming or coordinated spatial reuse may occur during service periods of the RTWT schedule.

FIG. 1 may represent a logical illustration of environment 100 for purposes of explaining concepts associated with the disclosure. The number of requesting access points, coordinated access points, user equipment devices, communication links, and network entities illustrated may vary across implementations. Additional coordinated access points, additional user equipment devices, or alternative network architectures may also be used.

Roles of requesting access point and coordinated access point may represent functional designations. An access point configured to transmit a Co-RTWT negotiation request message may operate as a requesting access point, while an access point configured to receive the Co-RTWT negotiation request message and transmit the Co-RTWT negotiation response message may operate as a coordinated access point. In certain deployments, an access point may operate as a requesting access point in one instance and may operate as a coordinated access point in another instance depending on the negotiation procedure being performed.

FIG. 1 is intended to provide a conceptual illustration for facilitating understanding of the described embodiments and may not impose limitations on physical arrangement, signaling order, message sequencing, or functional partitioning of the illustrated components. Equivalent configurations, alternative component arrangements, or modified interaction relationships that perform substantially similar functions using a Co-RTWT negotiation request message, a Co-RTWT negotiation response message, and RTWT schedule protection level information may also fall within the scope of the disclosure.

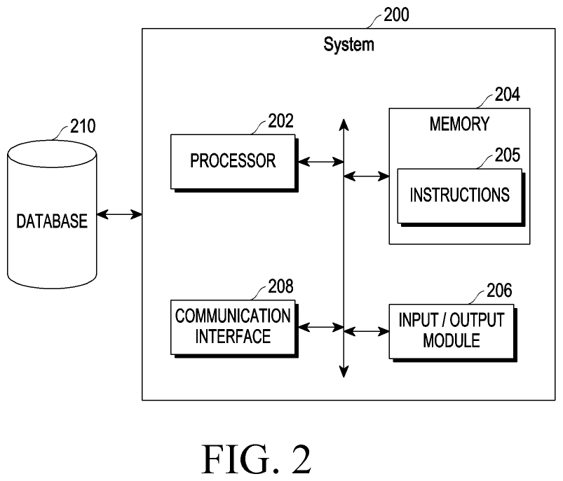

FIG. 2 illustrates an example internal block diagram of a system 200 that support management of Coordinated Restricted Target Wake Time (Co-RTWT) in a wireless local area network according to an embodiment of the disclosure. The system 200 may include a processor 202, memory 204 storing instructions 205, an input/output (I/O) module 206, a communication interface 208, and a database 210 operatively coupled with the system 200. The processor 202 may be communicatively coupled with the memory 204, the input/output module 206, the communication interface 208, and the database 210 through one or more internal buses, interfaces, or communication pathways. The components illustrated in FIG. 2 may represent a logical architecture of computing circuitry capable of supporting coordinated restricted target wake time scheduling and coordination among multiple access points within a wireless local area network.

The processor 202 illustrated in FIG. 2 may represent one or more processors associated with an access point participating in a Co-RTWT negotiation procedure. In some implementations, the processor 202 may include a single processing unit, while in other implementations the processor 202 may include multiple processors, processing cores, or distributed processing elements that may operate cooperatively to execute instructions stored in the memory 204. The processor 202 may include, for example, one or more microprocessors, digital signal processors, microcontrollers, programmable logic devices, application-specific integrated circuits, or other processing circuitry capable of executing program instructions.

The one or more processors represented by processor 202 may execute instructions 205 stored in the memory 204 in order to perform operations associated with management of Co-RTWT negotiation within the wireless local area network. The processing architecture illustrated in FIG. 2 may be implemented within multiple access points participating in Co-RTWT negotiation, including a requesting access point and one or more coordinated access points. Each participating access point may therefore include processing circuitry corresponding to processor 202 and memory 204 storing instructions configured to support the operations described herein.

The memory 204 may include one or more computer-readable storage media capable of storing executable instructions and operational data used during execution of the methods described in the disclosure. The memory 204 may include volatile memory such as dynamic random-access memory (DRAM) or static random-access memory (SRAM), as well as non-volatile memory such as read-only memory (ROM), flash memory, or electrically erasable programmable read-only memory (EEPROM). The memory 204 may store instructions 205 that, when executed by the processor 202, may cause the respective access point to perform operations associated with coordinated restricted target wake time negotiation and coordination.

In some embodiments, the system 200 may form part of a wireless local area network that includes a requesting access point and one or more coordinated access points. The processor 202 and the memory 204 within the requesting access point may execute instructions configured to cause the requesting access point to transmit a Co-RTWT negotiation request message to one or more coordinated access points through the communication interface 208. The Co-RTWT negotiation request message may include RTWT schedule protection level information associated with a restricted target wake time schedule maintained by the requesting access point.

The requesting access point may further receive, through the communication interface 208, a Co-RTWT negotiation response message from one or more coordinated access points. The response message may include an indication of a selection of coordinated beamforming or coordinated spatial reuse based on the RTWT schedule protection level information included in the negotiation request message. Based on the received response message, the requesting access point may establish a Co-RTWT agreement associated with the restricted target wake time schedule using the selected RTWT schedule protection level information.

Similarly, the processor 202 and memory 204 implemented within each coordinated access point may execute instructions configured to cause the coordinated access point to receive the Co-RTWT negotiation request message including the RTWT schedule protection level information from the requesting access point through the communication interface 208. The coordinated access point may evaluate the received RTWT schedule protection level information and may determine a coordination mechanism that may be supported by the coordinated access point.

In some implementations, the coordinated access point may select coordinated beamforming or coordinated spatial reuse based on the RTWT schedule protection level information and coordinated transmission capabilities of the coordinated access point. Such coordinated transmission capabilities may include antenna configuration capability of the coordinated access point, spatial stream capability supported by the coordinated access point, transmit power control capability, beamforming capability, or spatial reuse capability that may be supported by the coordinated access point.

After selection of a coordination mechanism, the coordinated access point may transmit the Co-RTWT negotiation response message through the communication interface 208 to the requesting access point. The response message may include an indication of the selected coordination mechanism, such as coordinated beamforming or coordinated spatial reuse. The coordinated access point may also establish the Co-RTWT agreement associated with the restricted target wake time schedule based on the selected RTWT schedule protection level information.

In some implementations, coordinated beamforming negotiation or coordinated spatial reuse negotiation may occur within the Co-RTWT negotiation procedure through exchange of coordinated beamforming information sets or coordinated spatial reuse information sets within the Co-RTWT negotiation request message and the Co-RTWT negotiation response message. In other implementations, coordinated beamforming or coordinated spatial reuse negotiation may occur after transmission of the Co-RTWT negotiation response message through additional message exchanges between the requesting access point and the coordinated access point.

The communication interface 208 may support communication between the requesting access point and one or more coordinated access points within the wireless local area network. The communication interface 208 may include radio frequency transceivers, baseband processing circuitry, and wireless protocol stack interfaces capable of supporting wireless communication protocols such as IEEE 802.11. Through the communication interface 208, the access points may exchange signaling messages associated with Co-RTWT negotiation, including Co-RTWT negotiation request messages, Co-RTWT negotiation response messages, coordinated beamforming information sets, coordinated spatial reuse information sets, trigger frames, and intra-basic service set announcements.

The input/output module 206 may provide interfaces through which configuration information may be received by the system 200 or operational information may be communicated from the system 200. In some implementations, the input/output module 206 may support configuration of access point parameters, monitoring of wireless network performance metrics, or interaction with external network management systems responsible for management of access points within the wireless local area network.

The database 210 may store operational data associated with management of restricted target wake time schedules and coordinated transmission mechanisms. The stored data may include RTWT schedule identifiers, RTWT schedule parameters, station information associated with RTWT schedules, negotiated coordination modes, antenna configuration parameters, spatial stream capability information, transmit power configuration parameters, and historical negotiation information associated with coordinated access points. Such data may be stored prior to operation of the system 200, updated dynamically during operation, or obtained from external network management systems.

Through coordinated operation of processing circuitry implemented within the requesting access point and the one or more coordinated access points, the system 200 may support coordinated management of restricted target wake time schedules across overlapping wireless networks. By enabling negotiation of coordination mechanisms such as coordinated beamforming or coordinated spatial reuse based on RTWT schedule protection level information, the system may support protection of scheduled transmissions during RTWT service periods while enabling efficient utilization of wireless communication resources.

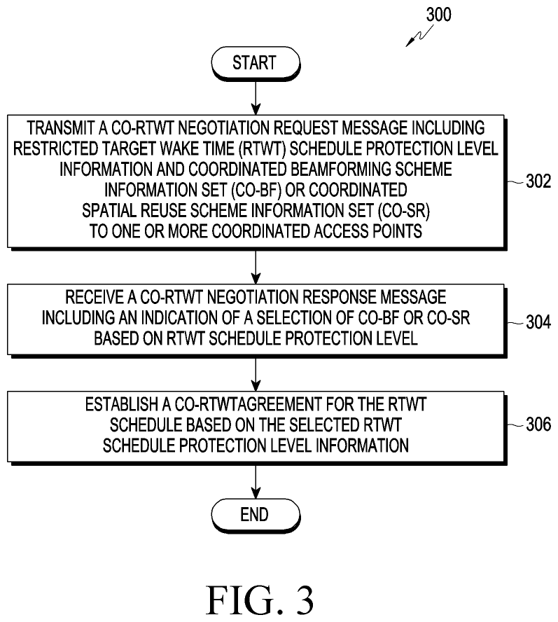

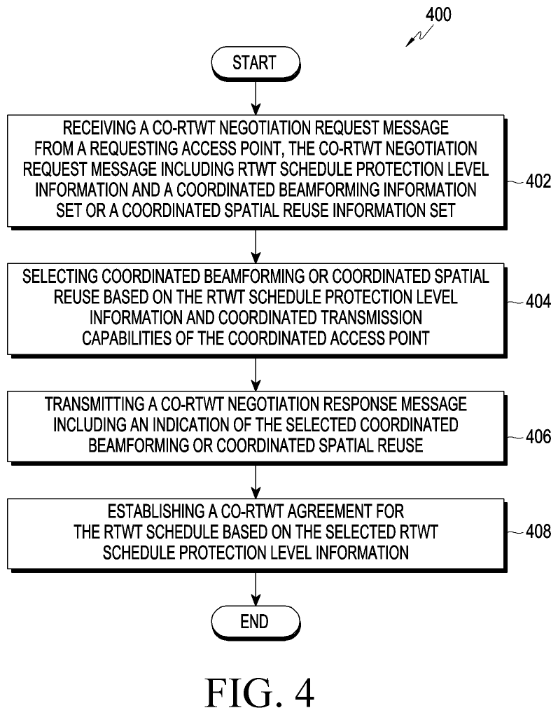

FIG. 3 illustrates a flow diagram of a method 300 for managing Coordinated Restricted Target Wake Time (Co-RTWT) in a wireless local area network, the method being performed by a requesting access point, according to an embodiment of the disclosure. FIG. 4 illustrates a complementary method performed by one or more coordinated access points that participate in the Co-RTWT negotiation according to an embodiment of the disclosure.

In various embodiments, the requesting access point may maintain one or more Restricted Target Wake Time (RTWT) schedules associated with one or more stations operating within a basic service set (BSS). The stations may include user equipment (as shown in FIG. 1) such as mobile devices, IoT devices, industrial wireless devices, or other Wi-Fi enabled stations that communicate with the requesting access point according to scheduled wake intervals defined by the RTWT schedule. Each RTWT schedule may define periodic service periods during which the associated stations wake and exchange uplink or downlink traffic with the requesting access point.

In dense wireless deployments, multiple access points may operate in overlapping coverage regions. Transmissions occurring during the RTWT service period of one access point may therefore be affected by transmissions originating from neighbouring BSS networks. To mitigate such interference and enable coordinated transmissions across multiple access points, the requesting access point may initiate a Coordinated Restricted Target Wake Time (Co-RTWT) negotiation with one or more neighbouring access points.

In some embodiments, the requesting access point may determine that coordination is required for protecting the RTWT schedule based on one or more operational conditions. Such conditions may include detection of overlapping BSS coverage regions, measured interference levels during the RTWT service period, traffic characteristics associated with the stations participating in the RTWT schedule, or scheduling requirements associated with latency-sensitive traffic flows. Based on such determination, the requesting access point may initiate a Co-RTWT negotiation procedure with one or more coordinated access points.

Referring to FIG. 3, at operation 302, the requesting access point may transmit a Co-RTWT negotiation request message including Restricted Target Wake Time (RTWT) schedule protection level information and a Coordinated Beamforming scheme information set (Co-BF) or a Coordinated Spatial Reuse scheme information set (Co-SR) to one or more coordinated access points.

In some embodiments, the Co-RTWT negotiation request message may be transmitted using a MAPC Negotiation Request frame. The MAPC Negotiation Request frame may contain a MAPC Negotiation Info field carrying a Negotiation MAPC Element Information Element (IE), as illustrated in FIG. 9.

Referring to FIG. 9, the MAPC Element IE may include the following fields:
Element ID
Length
Element ID Extension
MAPC Control
MAPC Common Info
MAPC Scheme Info

The MAPC Element IE may serve as a container structure through which coordination parameters associated with multiple coordination schemes may be exchanged between access points during the MAPC negotiation procedure.

The MAPC Scheme Info field may include one or more scheme-specific sub-elements corresponding to coordination schemes supported by the access points. Such scheme sub-elements may include a Co-RTWT Scheme sub-element, a Coordinated Beamforming (Co-BF) Scheme sub-element, and a Coordinated Spatial Reuse (Co-SR) Scheme sub-element.

The Co-RTWT Scheme sub-element may carry parameters required for negotiating protection of the RTWT schedule. As shown in FIG. 10, the Co-RTWT Scheme sub-element may include:
Sub-element ID
Length
Co-RTWT Scheme Control
Co-RTWT Scheme Information Set

The Sub-element ID uniquely identifies the Co-RTWT scheme sub-element among the various scheme sub-elements contained in the MAPC Scheme Info field.

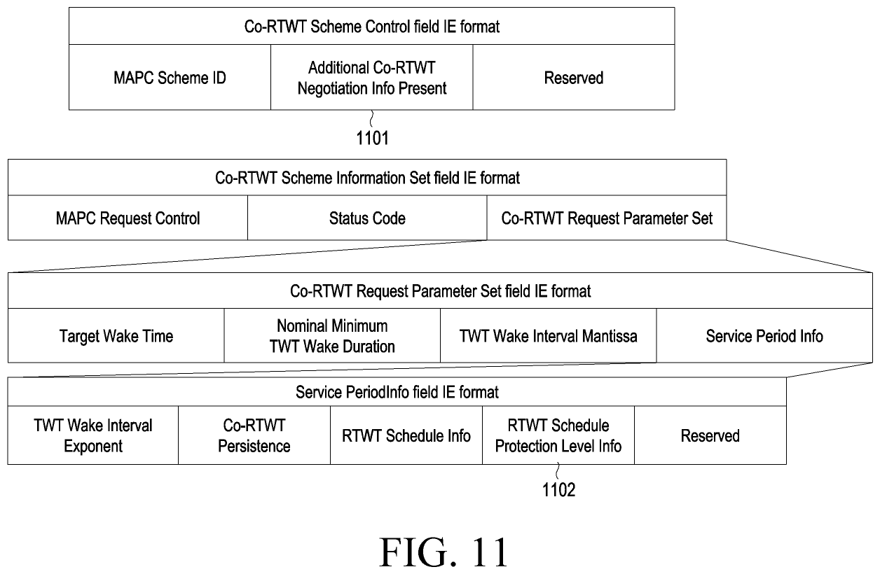

Referring to FIG. 11, The Co-RTWT Scheme Control field may include:
MAPC Scheme ID
Additional Co-RTWT Negotiation Info Present
Reserved

The MAPC Scheme ID field may identify the coordination scheme associated with the sub-element. For example, the MAPC Scheme ID may be set to a predefined value such as “3” to indicate that the sub-element corresponds to a Co-RTWT scheme.

The Additional Co-RTWT Negotiation Info Present field is introduced by the disclosure. This field may indicate whether additional negotiation parameters related to RTWT schedule protection are included in the Co-RTWT Scheme Information Set. For example, the field may be set to “1” if the RTWT Schedule Protection Level Info field is present and may be set to “0” otherwise.

The Co-RTWT Scheme Information Set may include parameters that define the RTWT schedule and the associated protection mechanism. As shown in FIG. 11, the Co-RTWT Scheme Information Set may include:
MAPC Request Control
Status Code
Co-RTWT Request Parameter Set

The MAPC Request Control field may indicate whether the message represents a request, response, or confirmation of the negotiation procedure. The Status Code field may indicate the result of the negotiation operation.

The Co-RTWT Request Parameter Set may include parameters describing the RTWT schedule that requires protection. These parameters may include:
Target Wake Time
Nominal Minimum TWT Wake Duration
TWT Wake Interval Mantissa
Service Period Info

The Target Wake Time field may indicate the scheduled wake time associated with the RTWT schedule.

The Nominal Minimum TWT Wake Duration field may indicate the minimum duration for which stations participating in the RTWT schedule remain awake during each service period.

The TWT Wake Interval Mantissa field may represent the interval between consecutive service periods of the RTWT schedule.

The Service Period Info field may include:
TWT Wake Interval Exponent
Co-RTWT Persistence
RTWT Schedule Info
RTWT Schedule Protection Level Info
Reserved

In some embodiments, the Reserved field may be introduced by the disclosure to allow future extension of coordination parameters.

The RTWT Schedule Protection Level Info field may indicate a coordination mode that determines whether transmission by one or more coordinated access points is permitted and how the transmission is performed during a protected service period of the RTWT schedule.

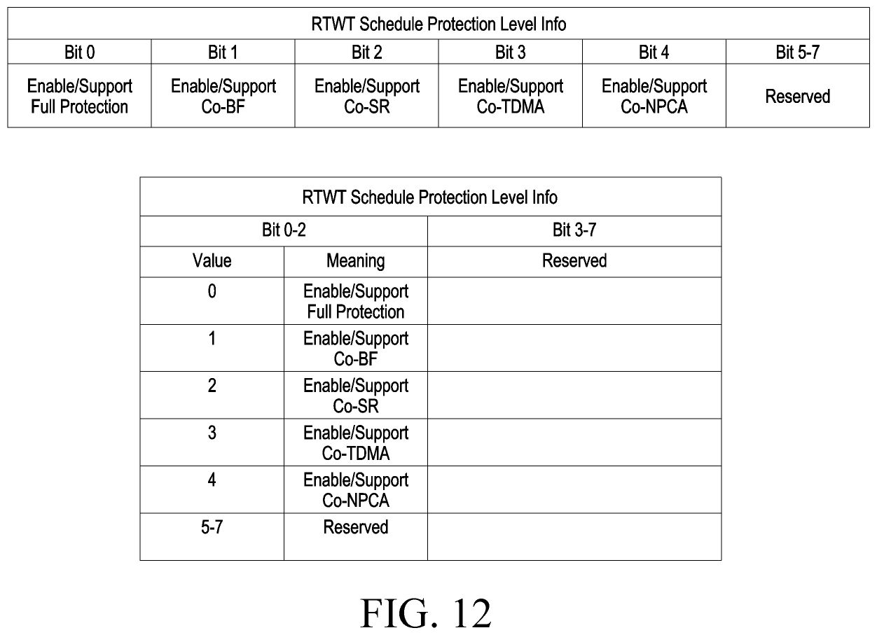

Referring to FIG. 12, the field may be encoded using a bit-based representation in which individual bits correspond to specific coordination mechanisms.

For example:
Bit 0—Enable or Support Full Protection
Bit 1—Enable or Support Coordinated Beamforming
Bit 2—Enable or Support Coordinated Spatial Reuse
Bit 3—Enable or Support Coordinated TDMA
Bit 4—Enable or Support Coordinated NPCA
Bits 5-7—Reserved

In an alternative embodiment as shown in FIG. 12, the RTWT Schedule Protection Level Info field may be encoded using a value-based representation where predefined values correspond to specific coordination modes.

In some embodiments, the Co-RTWT negotiation request message may further include Restricted Target Wake Time Station Information (RTWT STA Info) identifying one or more stations associated with the RTWT schedule. The RTWT STA Info field may be included within a scheme information set associated with the Co-RTWT negotiation, such as within the Co-BF Scheme Information Set or the Co-SR Scheme Information Set described with reference to FIGS. 13 and 14. The RTWT STA Info field may contain information identifying stations participating in the RTWT schedule, such as station identifiers, association identifiers (AIDs), or other station identification parameters corresponding to RTWT stations scheduled to transmit or receive traffic during RTWT service periods. By including RTWT STA Info within the negotiation messages, the coordinated access points may determine which stations are associated with the protected RTWT schedule and may configure coordinated transmissions relative to those stations during the protected service period.

At operation 304, the requesting access point may receive a Co-RTWT negotiation response message including an indication of a selected coordination mode based on the RTWT Schedule Protection Level Info field. The response message may include the selected coordination scheme and may provide parameters required to support the selected scheme.

At operation 306, the requesting access point may establish a Co-RTWT agreement for the RTWT schedule based on the selected RTWT schedule protection level information.

In some embodiments, establishing the Co-RTWT agreement may comprise transmitting a message to initiate coordinated beamforming negotiation or coordinated spatial reuse negotiation based on the selected protection level. In some embodiments, after establishment of the Co-RTWT agreement, the requesting access point may broadcast an intra-basic service set announcement indicating the RTWT schedule and the selected RTWT schedule protection level information to its associated stations so that the stations operate according to the negotiated coordination mechanism.

FIG. 4 illustrates the method 400 performed by a coordinated access point according to an embodiment of the disclosure.

Referring to FIG. 4, at operation 402, the coordinated access point may receive the Co-RTWT negotiation request message and extracts the MAPC Element IE shown in FIG. 9. The coordinated access point may parse the Co-RTWT Scheme sub-element illustrated in FIG. 10 and extract the RTWT Schedule Protection Level Info field shown in FIG. 12. At operation 404, the coordinated access point selects coordinated beamforming or coordinated spatial reuse based on the RTWT schedule protection level information and coordinated transmission capabilities of the coordinated access point.

In an embodiment, selecting the coordination mechanism may include evaluating antenna configuration and spatial stream capability of the coordinated access point. In other embodiments, selecting the coordination mechanism may further comprise evaluating transmit power control capability associated with coordinated spatial reuse.

In some embodiments, the coordinated access point may associate coordinated transmission parameters with the RTWT schedule identifier and RTWT station information received from the requesting access point.

The coordinated transmission parameters may include:
spatial stream information
antenna configuration information
transmit power information

Referring to FIG. 13, the Co-BF Scheme sub-element may include:
Sub-element ID
Length
Co-BF Scheme Control
Co-BF Scheme Information Set

The Co-BF Scheme Control field may include:
MAPC Scheme ID=0
Additional Co-BF Negotiation Info Present
Reserved

The Additional Co-BF Negotiation Info Present field introduced by the disclosure may indicate whether RTWT Schedule ID and RTWT STA Info fields are included in the Co-BF Scheme Information Set.

Referring to FIG. 14, the Co-SR Scheme sub-element may include:
Sub-element ID
Length
Co-SR Scheme Control
Co-SR Scheme Information Set

The Co-SR Scheme Control field may include:
MAPC Scheme ID=1
Additional Co-SR Negotiation Info Present
Reserved

At operation 406, the coordinated access point may transmit the Co-RTWT negotiation response message indicating the selected coordination scheme. At operation 408, the coordinated access point establishes the Co-RTWT agreement and performs transmissions according to the negotiated coordination mechanism during protected RTWT service periods.

The methods herein enable improved coordination of transmissions across multiple access points during restricted target wake time (RTWT) service periods. By enabling coordinated negotiation of protection mechanisms associated with RTWT schedules, the disclosure may allow multiple access points operating in overlapping coverage regions to coordinate transmissions in a manner that reduces interference and improves overall wireless network efficiency.

In particular, the introduction of the RTWT Schedule Protection Level Info field, as illustrated in FIG. 12, enables a requesting access point to explicitly indicate the coordination mode associated with protection of a RTWT schedule. The RTWT Schedule Protection Level Info field may allow coordinated access points to determine whether transmissions during the protected service period are to be restricted, coordinated through beamforming, coordinated through spatial reuse, or coordinated through other mechanisms. By providing explicit information regarding the requested protection mechanism, the coordinated access points may make more informed decisions regarding transmission scheduling during RTWT service periods.

The use of the MAPC Element Information Element (IE) illustrated in FIG. 9 may further allow multiple coordination schemes to be negotiated within a unified message structure. The MAPC Element IE may carry multiple scheme sub-elements including the Co-RTWT Scheme sub-element, Co-BF Scheme sub-element, and Co-SR Scheme sub-element. This structure may allow multiple coordination parameters to be exchanged between access points within a single negotiation procedure.

The Additional Co-RTWT Negotiation Info Present field, introduced in the Co-RTWT Scheme Control field as shown in FIG. 11, enables the requesting access point to indicate whether additional coordination parameters associated with RTWT schedule protection are present in the Co-RTWT Scheme Information Set. This capability may allow the negotiation process to flexibly include additional coordination information without modifying the base message structure.

Similarly, the Additional Co-BF Negotiation Info Present field and Additional Co-SR Negotiation Info Present field, introduced within the Co-BF Scheme Control and Co-SR Scheme Control fields respectively (as shown in FIGS. 13 and 14), enable the coordinated access points to determine whether additional parameters associated with the RTWT schedule are present within the corresponding scheme information sets. Such parameters may include the RTWT Schedule ID and RTWT STA Info fields introduced by the disclosure.

By associating the coordinated beamforming or coordinated spatial reuse parameters with the RTWT Schedule ID and RTWT Station Information fields, the disclosure enables coordinated access points to identify the specific RTWT schedule and stations that require protection. This association may allow coordinated access points to apply coordinated transmission mechanisms only during the relevant RTWT service periods, thereby improving spatial reuse opportunities and reducing unnecessary transmission restrictions.

In some embodiments, the coordinated access points may evaluate their antenna configuration, spatial stream capabilities, and transmit power control capabilities before selecting the coordination mechanism indicated in the RTWT Schedule Protection Level Info field. Such evaluation may allow the coordinated access points to determine whether coordinated beamforming or coordinated spatial reuse can be supported during the protected service period. As a result, the techniques described herein may enable improved protection of RTWT service periods while simultaneously allowing coordinated transmissions across multiple access points. This may improve channel utilization, reduce interference between overlapping BSS networks, and enhance the reliability of scheduled transmissions for stations participating in RTWT schedules.

Conventional MAPC negotiation mechanisms may allow coordination between access points for certain transmission parameters. However, conventional mechanisms typically do not provide explicit signaling for protection of restricted target wake time schedules across multiple access points.

In particular, conventional MAPC negotiation procedures may not include a field that explicitly indicates the coordination mechanism associated with protection of a RTWT schedule. The disclosure introduces the RTWT Schedule Protection Level Info field, which enables the requesting access point to indicate the specific coordination mechanism associated with protection of the RTWT schedule.

Additionally, conventional MAPC negotiation procedures may not provide a mechanism for associating coordinated transmission parameters with a specific RTWT schedule identifier and station information. The disclosure introduces the RTWT Schedule ID field and RTWT STA Info field, which enable coordinated access points to associate coordinated beamforming or spatial reuse parameters with the specific RTWT schedule requiring protection.

Furthermore, conventional MAPC negotiation procedures may not support flexible inclusion of additional negotiation parameters within scheme-specific sub-elements. The disclosure introduces the Additional Co-RTWT Negotiation Info Present, Additional Co-BF Negotiation Info Present, and Additional Co-SR Negotiation Info Present fields. These fields allow access points to dynamically indicate the presence of additional negotiation parameters without altering the underlying message format.

The disclosure also enables coordination mechanisms such as coordinated beamforming and coordinated spatial reuse to be negotiated within the same MAPC negotiation framework used for Co-RTWT negotiation. By allowing scheme-specific information sets for multiple coordination mechanisms to be carried within the MAPC Scheme Info field, the disclosure enables more efficient negotiation of coordinated transmission parameters across access points.

As a result, the methods and structures described herein provide enhanced coordination capabilities for protecting RTWT schedules across multiple access points. The disclosed techniques enable explicit signaling of protection mechanisms, association of coordination parameters with RTWT schedules and stations, and flexible inclusion of scheme-specific negotiation parameters within MAPC negotiation messages.

These improvements may enable more effective coordination of transmissions across overlapping wireless networks, thereby improving reliability of scheduled communications, reducing interference during protected service periods, and enhancing overall wireless network performance.

Accordingly, FIGS. 3 and 4 may collectively describe complementary and coordinated methods that may enable transmission of a Co-RTWT negotiation request message including RTWT schedule protection level information and a Coordinated Beamforming scheme information set (Co-BF) or a Coordinated Spatial Reuse scheme information set (Co-SR), selection of coordinated beamforming or coordinated spatial reuse based on coordinated transmission capabilities including antenna configuration, spatial stream capability, and transmit power information, association of coordinated transmission parameters with a RTWT schedule identifier and RTWT Station Information, and establishment of a Co-RTWT agreement enabling coordinated operation during service periods of a RTWT schedule.

FIG. 5 illustrates a sequence flow of a method for managing Coordinated Restricted Target Wake Time (Co-RTWT) in a wireless local area network, where coordinated beamforming negotiation or coordinated spatial reuse negotiation and agreement formation may be performed jointly as part of a Co-RTWT negotiation according to an embodiment of the disclosure. The signaling exchanged between a requesting access point and a coordinated access point may enable coordinated transmission behaviour during protected service periods of a RTWT schedule.

At Signal 1 (operation 501), a Co-RTWT requesting access point may transmit a Co-RTWT negotiation request message to one or more coordinated access points. The Co-RTWT negotiation request message may include a Co-RTWT Scheme Information set together with a Coordinated Beamforming scheme information set (Co-BF) or a Coordinated Spatial Reuse scheme information set (Co-SR) that may be used for coordinated negotiation.

The Co-RTWT negotiation request message may include RTWT Schedule Protection Level Information corresponding to one or more requested RTWT schedules. The RTWT Schedule Protection Level Information may include a parameter that indicates a coordination mode governing whether transmission by one or more coordinated access points may occur during a protected service period of the RTWT schedule and how such transmission may be performed. For example, the RTWT Schedule Protection Level Information may indicate that coordinated beamforming or coordinated spatial reuse can be enabled for the RTWT schedule.

In some implementations, the Co-RTWT negotiation request message may further include Restricted Target Wake Time station information identifying one or more stations associated with the RTWT schedule. This RTWT STA Information may allow the coordinated access point to determine which stations may be associated with the protected RTWT schedule.

The Co-RTWT negotiation request message may also include parameters such as Additional Co-BF/Co-SR Negotiation Info Present, RTWT Schedule ID, and RTWT STA Info. The RTWT Schedule ID may identify the RTWT schedule associated with the requested coordination. The Additional Co-BF/Co-SR Negotiation Info Present field may indicate that the Coordinated Beamforming scheme information set or the Coordinated Spatial Reuse scheme information set may be included in the same Co-RTWT negotiation request message. The Coordinated Beamforming scheme information set or Coordinated Spatial Reuse scheme information set may include parameters that may be used for coordinated beamforming or coordinated spatial reuse negotiation, such as spatial stream information, antenna configuration information, transmit power information, and other coordinated transmission parameters. These parameters may be exchanged together with the Co-RTWT Scheme Information set during the Co-RTWT negotiation phase.

At Signal 2, the coordinated access point may be configured to receive the Co-RTWT negotiation request message and may evaluate the RTWT Schedule Protection Level Information together with the Coordinated Beamforming scheme information set or the Coordinated Spatial Reuse scheme information set. Based on this evaluation, the coordinated access point may select a RTWT protection mode supported by its coordinated transmission capabilities.

Selection of the RTWT Schedule Protection Level Information may involve evaluating antenna configuration capability and spatial stream capability of the coordinated access point. In some implementations, the coordinated access point may also evaluate transmit power control capability associated with coordinated spatial reuse. Based on such evaluation, the coordinated access point may determine whether coordinated beamforming or coordinated spatial reuse may be supported for the requested RTWT schedule.

At operation 502, the coordinated access point may transmit a Co-RTWT negotiation response message that indicates the selected coordination mode. The response message may include a Co-RTWT Scheme Information set indicating the selected RTWT Schedule Protection Level Information and may also include a Coordinated Beamforming scheme information set or Coordinated Spatial Reuse scheme information set that may be used to complete the coordinated negotiation. Coordinated transmission parameters may be associated with the RTWT Schedule ID and RTWT STA Information so that the selected coordination mode may correspond to the specific RTWT schedule.

At Signal 3 (operation 503), after exchange of the Co-RTWT negotiation request message and the Co-RTWT negotiation response message, a final Co-RTWT negotiation confirmation and agreement formation phase may occur. In the embodiment illustrated in FIG. 5, coordinated beamforming negotiation or coordinated spatial reuse negotiation may be completed within the Co-RTWT negotiation messages themselves.

The requesting access point may establish a Co-RTWT agreement for the RTWT schedule based on the selected RTWT Schedule Protection Level Information. Similarly, the coordinated access point may establish the Co-RTWT agreement corresponding to the RTWT schedule. The Co-RTWT agreement may influence coordinated transmission behaviour during service periods of the RTWT schedule. In some implementations, coordinated beamforming negotiation or coordinated spatial reuse negotiation may be performed using an existing coordinated beamforming or coordinated spatial reuse negotiation procedure within the Co-RTWT negotiation framework.

At Signals 4 and 5 (operations 504 and 505, respectively), after the Co-RTWT negotiation may be completed and the Co-RTWT agreement may be established, the Co-RTWT requesting access point and the coordinated access point may broadcast the negotiated RTWT schedule and the selected RTWT Schedule Protection Level Information to their associated stations as an intra-basic service set announcement.

The intra-basic service set announcement may indicate the RTWT schedule, the selected RTWT Schedule Protection Level Information, and the coordination mode that may apply during the protected service period, such as coordinated beamforming or coordinated spatial reuse. This announcement may indicate completion of the Co-RTWT negotiation phase and may allow associated stations to operate according to the established Co-RTWT agreement during the RTWT service period.

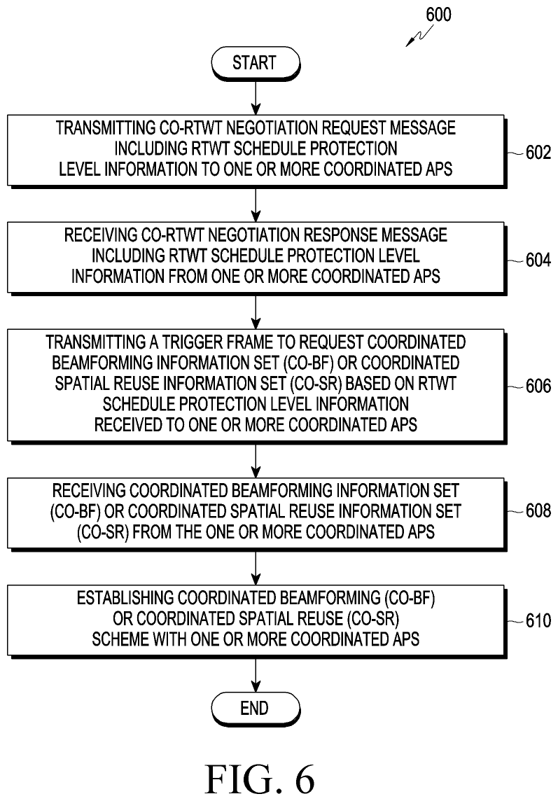

FIG. 6 illustrates a flow diagram of a method 600 for managing Coordinated Restricted Target Wake Time (Co-RTWT) in a wireless local area network, the method being performed by a requesting access point according to an embodiment of the disclosure. In this embodiment, coordinated beamforming negotiation or coordinated spatial reuse negotiation may not be completed within the Co-RTWT negotiation message exchange itself. Instead, the Co-RTWT negotiation phase may first determine RTWT Schedule Protection Level Information corresponding to one or more RTWT schedules. Coordinated beamforming negotiation or coordinated spatial reuse negotiation may then proceed as a separate and subsequent phase. In some implementations, certain parameters that may later be used for coordinated beamforming negotiation or coordinated spatial reuse negotiation can optionally be exchanged during the Co-RTWT negotiation phase in order to facilitate the later negotiation stage.

The requesting access point may maintain one or more Restricted Target Wake Time (RTWT) schedules associated with one or more stations. When coordinated operation during a protected service period of a RTWT schedule may be desirable, the requesting access point may initiate a Co-RTWT negotiation with one or more coordinated access points.

Referring to FIG. 6, at operation 602, the requesting access point may transmit a Co-RTWT negotiation request message including RTWT Schedule Protection Level Information to one or more coordinated access points. The RTWT Schedule Protection Level Information may include a parameter that indicates a coordination mode governing whether transmissions by one or more coordinated access points may occur during a protected service period of the RTWT schedule and how such transmissions may be performed. For example, the coordination mode may indicate that coordinated beamforming or coordinated spatial reuse can be enabled for the RTWT schedule.

The Co-RTWT negotiation request message may include a Co-RTWT Scheme Information set containing one or more RTWT Schedule IDs that identify the RTWT schedule or schedules under negotiation. In some embodiments, Restricted Target Wake Time station information identifying one or more stations associated with the RTWT schedule may optionally be exchanged during this phase. Although coordinated beamforming negotiation or coordinated spatial reuse negotiation may not be finalized during the Co-RTWT negotiation phase, certain parameters that may later be used for coordinated beamforming or coordinated spatial reuse negotiation can optionally be included. For example, an indication such as Additional Co-BF/Co-SR Negotiation Info Present may be included to signal that additional coordinated transmission negotiation may follow.

At operation 604, the requesting access point may receive a Co-RTWT negotiation response message including RTWT Schedule Protection Level Information from one or more coordinated access points. The coordinated access point may evaluate the received RTWT Schedule Protection Level Information and may select a coordination mode that can be supported based on the coordinated transmission capabilities of the coordinated access point. The response message may indicate whether coordinated beamforming or coordinated spatial reuse can be supported for the requested RTWT schedule. At this stage, the protection mechanism associated with the RTWT schedule may be identified, while coordinated beamforming scheme parameters or coordinated spatial reuse scheme parameters may not yet be fully negotiated.

At operation 606, the requesting access point may transmit a trigger frame requesting a Coordinated Beamforming information set (Co-BF) or a Coordinated Spatial Reuse information set (Co-SR) based on the RTWT Schedule Protection Level Information received from the coordinated access point. The trigger frame may initiate coordinated beamforming negotiation or coordinated spatial reuse negotiation as a separate and subsequent phase. In some implementations, the trigger frame may include an RTWT Schedule ID and may indicate that coordinated beamforming negotiation or coordinated spatial reuse negotiation may be performed for the identified RTWT schedule.

In certain implementations, the trigger frame may be optional, and the requesting access point may initiate coordinated beamforming negotiation or coordinated spatial reuse negotiation directly after receiving the Co-RTWT negotiation response.

At operation 608, the requesting access point may receive the Coordinated Beamforming information set or the Coordinated Spatial Reuse information set from one or more coordinated access points. The Coordinated Beamforming information set, or Coordinated Spatial Reuse information set may include parameters that may be used during coordinated beamforming negotiation or coordinated spatial reuse negotiation. Such parameters may include, for example, the number of spatial streams, the number of transmit antennas, the number of receive antennas, transmit power information, antenna configuration information, RTWT Schedule ID, RTWT STA Information, and an indication such as Additional Co-BF/Co-SR Negotiation Info Present. Additional parameters associated with coordinated transmission behaviour may also be exchanged depending on implementation requirements, and the exact set of parameters used for coordinated beamforming or coordinated spatial reuse negotiation may vary across implementations.

At operation 610, the requesting access point may establish a Coordinated Beamforming scheme or a Coordinated Spatial Reuse scheme with one or more coordinated access points. The negotiated scheme may be associated with the RTWT Schedule ID and may influence transmission behaviour during service periods of the RTWT schedule. After coordinated beamforming negotiation or coordinated spatial reuse negotiation is completed, a Co-RTWT agreement corresponding to the RTWT schedule may be finalized.

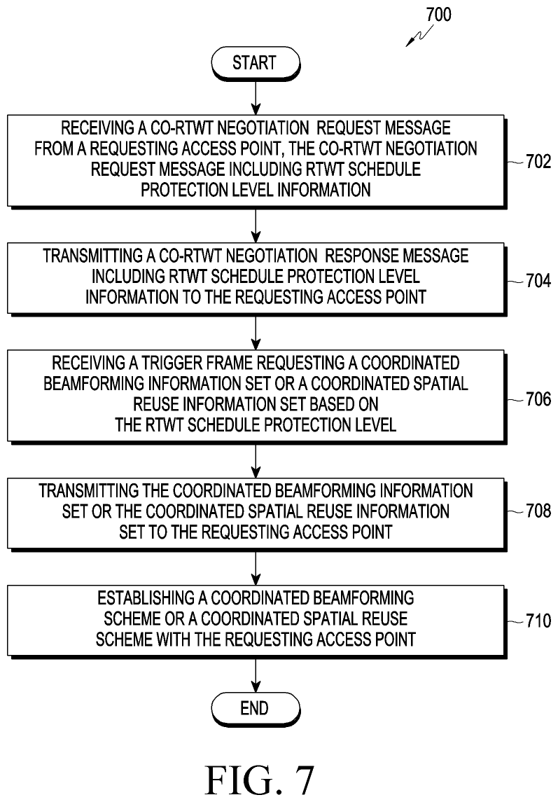

FIG. 7 illustrates a flow diagram of a method 700 performed by a coordinated access point corresponding to the embodiment described with reference to FIG. 6 according to an embodiment of the disclosure.

Referring to FIG. 7, at operation 702, the coordinated access point may be configured to receive a Co-RTWT negotiation request message from a requesting access point. The received message includes RTWT Schedule Protection Level Information associated with a restricted target wake time schedule. Upon receipt of the message, the coordinated access point may parse the Co-RTWT Scheme Information set and evaluate the requested coordination mode indicated by the RTWT Schedule Protection Level Information. Based on this evaluation, the coordinated access point may determine whether the requested protection mechanism can be supported during the protected service period of the RTWT schedule.

At operation 704, the coordinated access point may be configured to transmit a Co-RTWT negotiation response message to the requesting access point. The response message may include RTWT Schedule Protection Level Information indicating the coordination mode selected by the coordinated access point. In determining the selected coordination mode, the coordinated access point may evaluate its coordinated transmission capabilities. For example, the coordinated access point may consider its antenna configuration and spatial stream capability supported for coordinated transmissions. In some embodiments, the coordinated access point may additionally evaluate transmit power control capability, particularly in cases where coordinated spatial reuse is considered. Based on these evaluations, the coordinated access point may determine whether coordinated beamforming or coordinated spatial reuse can be supported during the protected service period of the RTWT schedule.

At operation 706, the coordinated access point may be configured to receive a trigger frame from the requesting access point requesting a Coordinated Beamforming information set or a Coordinated Spatial Reuse information set. The trigger frame may initiate a subsequent negotiation phase in which parameters required for coordinated beamforming or coordinated spatial reuse are exchanged separately from the initial Co-RTWT negotiation.

At operation 708, the coordinated access point may be configured to transmit the Coordinated Beamforming information set or the Coordinated Spatial Reuse information set to the requesting access point. The transmitted information set may include coordinated transmission parameters such as spatial stream information, antenna configuration information, transmit power information, or other parameters relevant to coordinated transmission behaviour. In some embodiments, the coordinated access point may associate the coordinated transmission parameters with a RTWT Schedule ID and RTWT STA Information, thereby linking the negotiated coordinated transmission behaviour to the RTWT schedule and the stations participating in the RTWT agreement.

At operation 710, the coordinated access point may be configured to establish a Coordinated Beamforming scheme or a Coordinated Spatial Reuse scheme with the requesting access point. In certain embodiments, coordinated beamforming negotiation or coordinated spatial reuse negotiation may be performed using an existing coordinated beamforming or coordinated spatial reuse negotiation procedure that operates independently of the Co-RTWT negotiation message exchange. Once the negotiation is completed, the coordinated access point and the requesting access point may apply the negotiated coordination scheme during the protected service periods of the RTWT schedule.

FIG. 8 illustrates the signaling interaction between a Co-RTWT requesting access point and a Co-RTWT coordinated access point in an embodiment where coordinated beamforming (Co-BF) or coordinated spatial reuse (Co-SR) negotiation may be performed separately from the initial Co-RTWT negotiation according to an embodiment of the disclosure.

In Signal 1 (operation 801), the Co-RTWT requesting access point may transmit a Co-RTWT negotiation request message to the coordinated access point. The request message may include RTWT Schedule Protection Level Information corresponding to one or more requested RTWT schedules. The RTWT Schedule Protection Level Information may be included within a Co-RTWT Scheme Information set carried in the Co-RTWT negotiation request message and may indicate a coordination mode governing how transmissions from neighbouring access points may occur during protected service periods of the RTWT schedule.

During this phase, the Co-RTWT requesting access point may optionally include RTWT STA Information together with other Co-RTWT parameters. The RTWT STA Information may identify one or more stations associated with the RTWT schedule and participating in RTWT transmissions. In some embodiments, the Co-RTWT requesting access point may also include preparatory indicators, such as an Additional Co-BF/Co-SR Negotiation Info Present field, which may indicate that coordinated beamforming negotiation or coordinated spatial reuse negotiation may follow the Co-RTWT negotiation phase.

In Signal 2, the Co-RTWT coordinated access point may receive the Co-RTWT negotiation request message and may evaluate the RTWT Schedule Protection Level Information contained in the message. Based on its transmission capabilities, the coordinated access point may select a suitable RTWT Schedule Protection Level Information supported by the coordinated access point. In operation 802, the coordinated access point may then transmit a Co-RTWT negotiation response message including the selected RTWT Schedule Protection Level Information to the requesting access point. In selecting the protection level, the coordinated access point may evaluate parameters such as antenna configuration, spatial stream capability, and transmit power capability.

In Signal 3 (operation 803), the Co-RTWT requesting access point may initiate a subsequent coordinated negotiation phase. In some implementations, the requesting access point may transmit a trigger frame requesting initiation of coordinated beamforming negotiation or coordinated spatial reuse negotiation. In other implementations, the coordinated negotiation phase may begin without a separate trigger frame, for example when negotiation may be initiated directly after exchange of the Co-RTWT negotiation response message.

In Signal 4 (operation 804), the Co-RTWT requesting access point and the Co-RTWT coordinated access point may exchange a Coordinated Beamforming scheme information set or a Coordinated Spatial Reuse scheme information set. These information sets may include parameters that may be used for coordinated beamforming negotiation or coordinated spatial reuse negotiation between the access points.

In some embodiments, the exchanged parameters may include the number of spatial streams supported for coordinated transmission, the number of transmit antennas, the number of receive antennas, antenna configuration information, transmit power information, RTWT Schedule ID, RTWT STA Information, and an indication such as Additional Co-BF/Co-SR Negotiation Info Present. Additional parameters relevant to coordinated beamforming or coordinated spatial reuse may also be exchanged depending on implementation requirements. The exact set of parameters used during the coordinated negotiation may vary across implementations.

In operation 805, after coordinated beamforming negotiation or coordinated spatial reuse negotiation is completed, the requesting access point and the coordinated access point may establish a Co-RTWT agreement corresponding to the negotiated coordination scheme. In some embodiments, an optional confirmation message exchange may occur between the access points to indicate completion of the negotiation.

Following establishment of the Co-RTWT agreement, the Co-RTWT requesting access point and the coordinated access point may broadcast the negotiated RTWT schedule and associated parameters to their respective associated stations (in operations 806 and 807, respectively). These broadcasts may be transmitted as intra-basic service set announcements and may include the negotiated RTWT Schedule Protection Level Information together with other RTWT schedule parameters.

Such intra-basic service set announcements may indicate completion of the Co-RTWT negotiation phase and may enable associated stations to operate according to the negotiated coordination scheme during protected RTWT service periods. Consequently, RTWT transmissions associated with the requesting access point may experience reduced interference, while coordinated access points may continue serving their associated stations using coordinated beamforming or coordinated spatial reuse techniques.

In this embodiment, the Co-RTWT negotiation phase may be separated from the coordinated beamforming negotiation or coordinated spatial reuse negotiation phase. Certain preparatory parameters may still be exchanged during the Co-RTWT negotiation stage, while detailed coordinated transmission parameters may be negotiated through subsequent signaling exchanges. This approach may provide flexibility in implementation and may support compatibility with existing coordinated beamforming or coordinated spatial reuse negotiation procedures while enabling coordinated protection of RTWT transmissions.

FIG. 9 depicts a Multi-Access Point Coordination (MAPC) Element Information Element (IE) format used for managing Coordinated Restricted Target Wake Time (Co-RTWT) in a wireless local area network, the MAPC Element IE format including fields for carrying scheme-specific information associated with Co-RTWT negotiation, according to embodiment of the disclosure.

FIG. 10 depicts a Co-RTWT Scheme sub-element Information Element (IE) format configured to carry RTWT schedule protection level information and related parameters for establishment of a Co-RTWT agreement for a RTWT schedule, according to an embodiment of the disclosure.

FIG. 11 depicts Information Elements configured to enable RTWT schedule protection as part of a Co-RTWT negotiation, the Information Elements including RTWT schedule protection level information and associated fields for indicating coordination mode during a protected service period of the RTWT schedule, for example an Additional Co-RTWT Negotiation Info Present field 1101 and an RTWT Schedule Protection Level Info field 1102, according to an embodiment of the disclosure.

FIG. 12 depicts a RTWT Schedule Protection Level Info field format configured to indicate a coordination mode that determines whether transmission by one or more coordinated access points is permitted and how the transmission is performed during a protected service period of a RTWT schedule, according to an embodiment of the disclosure.

FIG. 13 depicts a Coordinated Beamforming scheme sub-element Information Element (Co-BF Scheme sub-element IE) format configured to carry a Coordinated Beamforming scheme information set (Co-BF) for use in a Co-RTWT negotiation and establishment of a Co-RTWT agreement for a RTWT schedule, including, for example, an Additional Co-BF Negotiation Info Present field 1301, a RTWT Schedule ID field 1302, and a RTWT STA info field 1303, according to an embodiment of the disclosure.

FIG. 14 depicts a Coordinated Spatial Reuse scheme sub-element Information Element (Co-SR Scheme sub-element IE) format configured to carry a Coordinated Spatial Reuse scheme information set (Co-SR) for use in a Co-RTWT negotiation and establishment of a Co-RTWT agreement for a RTWT schedule, for example, including an Additional Co-SR Negotiation Info Present field 1401, a RTWT Schedule ID field 1402, and a RTWT STA info field 1403, according to an embodiment of the disclosure.

### Working Example

In a wireless local area network deployment, multiple access points may operate within overlapping coverage regions, each serving a number of stations within its respective basic service set (BSS). In such dense deployments, transmissions from neighbouring access points may interfere with one another, particularly when latency-sensitive traffic is scheduled between an access point and its associated stations. To address such issues, wireless networks may support multi-access point (MAP) coordination features that allow neighbouring access points to coordinate their transmissions in order to improve transmission reliability and reduce interference. One such MAP coordination mechanism is Coordinated Restricted Target Wake Time (Co-RTWT), which enables neighbouring access points to coordinate their transmissions in order to protect latency-sensitive traffic exchanged according to a restricted target wake time (RTWT) schedule.

By way of example, a first access point, AP1, may operate as a requesting access point and may have one or more stations within its BSS that support RTWT operation. AP1 may negotiate RTWT agreements with such stations in order to schedule uplink or downlink traffic that is sensitive to latency. In an illustrative scenario, the stations may include RTWT stations STA11 and STA12, each supporting RTWT operation and having latency-sensitive traffic flows identified using RTWT traffic identifiers (RTWT TIDs). Following negotiation of the RTWT agreement, AP1 may establish an RTWT schedule that defines one or more protected service periods during which latency-sensitive data exchange occurs between AP1 and the associated RTWT stations.

In environments where neighbouring access points operate in overlapping basic service sets, transmissions from another access point may occur during the RTWT service periods defined by AP1. For example, a second access point AP2 operating in an overlapping basic service set (OBSS) may perform transmissions independently of AP1. When such transmissions overlap with the RTWT service periods, interference may occur. This interference may result in packet loss, retransmissions, and degraded latency performance for the RTWT stations communicating with AP1.

To mitigate such interference, the requesting access point AP1 may initiate a Co-RTWT negotiation procedure with a neighbouring access point, such as AP2, which operates as a coordinated access point. During this negotiation procedure, AP1 may transmit a Co-RTWT negotiation request message that includes RTWT schedule protection level information corresponding to the RTWT schedule used for latency-sensitive transmissions. The RTWT schedule protection level information may indicate a coordination mode that specifies whether transmissions from neighbouring access points are permitted during the protected service periods and, if permitted, how such transmissions are performed.

Depending on the capabilities of the participating access points, the negotiated protection mechanism may correspond to one of several coordination modes supported in a multi-access point coordination framework. For example, the protection mechanism may include enabling full protection, enabling coordinated beamforming (Co-BF), enabling coordinated spatial reuse (Co-SR), enabling coordinated time division multiple access (Co-TDMA), or enabling coordinated non-primary channel access (Co-NPCA). When full protection is selected, transmissions from the coordinated access point AP2 may be restricted during the RTWT service periods of AP1 in order to fully protect the latency-sensitive traffic scheduled for the RTWT stations. In other coordination modes, such as coordinated beamforming or coordinated spatial reuse, transmissions may occur simultaneously while applying coordination techniques that reduce interference between the overlapping basic service sets.

In an example where coordinated beamforming (Co-BF) is selected as the protection mechanism, AP1 and AP2 may coordinate beamforming parameters so that transmission beams are directed toward their respective stations while reducing interference toward the transmissions of the other access point. In another scenario, where coordinated spatial reuse (Co-SR) is selected, AP2 may adjust parameters such as transmit power levels, spatial reuse parameters, or channel access behaviour in order to allow simultaneous transmissions while minimizing interference to the RTWT transmissions performed by AP1.

In certain embodiments, additional coordination techniques may also be negotiated. For example, coordinated time division multiple access (Co-TDMA) may be used so that AP1 and AP2 schedule their transmissions during different time intervals, thereby avoiding overlapping transmissions during the protected RTWT service periods. In another embodiment, coordinated non-primary channel access (Co-NPCA) may allow coordinated access points to transmit using non-primary channels or secondary channels in order to reduce interference with RTWT transmissions occurring on the primary channel.

Once the protection mechanism has been negotiated, AP1 and AP2 may establish a Co-RTWT agreement corresponding to the selected coordination mode. The Co-RTWT agreement enables the participating access points to operate in a coordinated manner during RTWT service periods. For instance, AP1 may continue to exchange latency-sensitive traffic with its RTWT stations STA11 and STA12 according to the RTWT schedule, while AP2 may continue to serve its associated stations in accordance with the negotiated coordination mechanism.

As a result, the negotiated protection mechanism may provide benefits to both basic service sets. In the BSS associated with AP1, the coordination mechanism reduces interference during RTWT service periods, thereby improving latency performance for latency-sensitive traffic. At the same time, the BSS associated with AP2 may continue to support transmissions for its own stations through coordinated or parallel transmission opportunities. In this way, coordinated operation between access points improves overall network efficiency while protecting latency-sensitive communications.

Accordingly, the disclosure provides a system and method for managing Coordinated Restricted Target Wake Time (Co-RTWT) in a wireless local area network through coordinated negotiation between a requesting access point and one or more coordinated access points. The requesting access point may negotiate a protection mechanism for a restricted target wake time schedule associated with latency-sensitive traffic exchanged with one or more RTWT stations. The negotiation utilizes RTWT schedule protection level information that indicates a coordination mode defining whether transmissions by coordinated access points are permitted during protected service periods and, when permitted, how those transmissions are performed.

The disclosed techniques may be implemented in multiple operational embodiments. In one embodiment, coordinated beamforming (Co-BF) or coordinated spatial reuse (Co-SR) negotiation and agreement formation are performed jointly with the Co-RTWT negotiation. In such cases, Co-BF or Co-SR scheme information sets and related parameters, including RTWT station information, spatial stream parameters, or antenna configuration information, may be exchanged together with the Co-RTWT scheme information set as part of the Co-RTWT negotiation message exchange. In another embodiment, Co-BF or Co-SR negotiation may be performed separately after initiation of the Co-RTWT negotiation. In such cases, certain parameters required for coordinated transmission negotiation may be exchanged during the Co-RTWT negotiation phase, while additional message exchanges are subsequently performed in order to complete the coordinated beamforming or coordinated spatial reuse negotiation.

By enabling flexible coordination mechanisms such as full protection, coordinated beamforming, coordinated spatial reuse, coordinated time division multiple access, or coordinated non-primary channel access, the techniques described herein protect latency-sensitive RTWT transmissions from interference caused by overlapping basic service sets. At the same time, the approach allows coordinated transmissions in neighbouring access point networks, thereby supporting efficient multi-access point operation. Consequently, the disclosure improves reliability of latency-sensitive wireless communications, reduces interference between overlapping access points, and enhances overall network efficiency during restricted target wake time service periods.

The illustrated operations are set out to explain the embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items.

Furthermore, one or more computer-readable storage media may be utilized in implementing embodiments consistent with the disclosure. A computer readable storage medium refers to any type of physical memory on which information or data readable by a processor may be stored. Thus, a computer readable storage medium may store instructions for execution by one or more processors, including instructions for causing the processor(s) to perform operations or stages consistent with the embodiments described herein. The term “computer readable medium” should be understood to include tangible items and exclude carrier waves and transient signals, i.e., are non-transitory. Examples include random access memory (RAM), read-only memory (ROM), volatile memory, non-volatile memory, hard drives, compact disc ROMs (CD ROMs), digital versatile discs (DVDs), flash drives, disks, and any other known physical storage media.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for managing coordinated restricted target wake time (Co-RTWT) by a requesting access point in a wireless communication network, the method comprising:
transmitting a Co-RTWT negotiation request message including information about restricted target wake time (RTWT) schedule protection level indicating at least one of coordinated beamforming (Co-BF) or coordinated spatial reuse (Co-SR) is usable for a RTWT schedule, to one or more coordinated access points;
receiving a Co-RTWT negotiation response message including an indication of a selection of the Co-BF or the Co-SR based on the information about the RTWT schedule protection level; and
establishing a Co-RTWT agreement for the RTWT schedule based on the selected Co-BF or Co-SR.

2. The method of claim 1, wherein the information about the RTWT schedule protection level comprises a parameter configured to indicate a coordination mode that determines whether transmission by the one or more coordinated access points is permitted and how the transmission is performed during a protected service period of the RTWT schedule.

3. The method of claim 1, wherein the Co-RTWT negotiation request message comprises restricted target wake time station information identifying one or more stations associated with the RTWT schedule.

4. The method of claim 1, wherein establishing the Co-RTWT agreement comprises transmitting a message to initiate coordinated beamforming negotiation or coordinated spatial reuse negotiation based on the selected Co-BF or Co-SR.

5. The method of claim 1, further comprising:
including in the Co-RTWT negotiation request message a Co-BF scheme information set or a Co-SR scheme information set; and
associating the Co-BF or Co-SR with a restricted target wake time schedule identifier.

6. The method of claim 1, further comprising broadcasting an intra-basic service set announcement indicating the RTWT schedule and the selected Co-BF or Co-SR to its associated stations.

7. The method of claim 1, wherein the Co-RTWT agreement enables the one or more coordinated access points to perform transmissions corresponding to the Co-BF or the Co-SR during service periods of the RTWT schedule.

8. A method for managing coordinated restricted target wake time (Co-RTWT) by a coordinated access point in a wireless communication network, the method comprising:
receiving a Co-RTWT negotiation request message from a requesting access point, the Co-RTWT negotiation request message including information about RTWT schedule protection level indicating at least one of coordinated beamforming (Co-BF) or a coordinated spatial reuse (Co-SR) is usable for a RTWT schedule;
selecting the Co-BF or the Co-SR based on the information about the RTWT schedule protection level and coordinated transmission capabilities of the coordinated access point;
transmitting a Co-RTWT negotiation response message including an indication of the selected Co-BF or Co-SR; and
establishing a Co-RTWT agreement for the RTWT schedule based on the selected Co-BF or Co-SR.

9. The method of claim 8, wherein the Co-RTWT agreement enables the coordinated access point to perform transmissions corresponding to the Co-BF or the Co-SR during service periods of the RTWT schedule.

10. The method of claim 8, wherein selecting the Co-BF or the Co-SR comprises evaluating antenna configuration and spatial stream capability of the coordinated access point.

11. The method of claim 8, wherein selecting the Co-BF or the Co-SR comprises evaluating transmit power control capability associated with the Co-SR.

12. The method of claim 8, further comprising:
associating at least one coordinated transmission parameter with a RTWT schedule identifier and RTWT station information.

13. The method of claim 12, wherein the at least one coordinated transmission parameter comprises at least one of spatial stream information, antenna configuration information, or transmit power information.

14. The method of claim 8, comprising:
performing Co-BF negotiation or Co-SR negotiation using an existing Co-BF or Co-SR negotiation procedure within a Co-RTWT negotiation.

15. A requesting access point for managing coordinated restricted target wake time (Co-RTWT) in a wireless communication network, the requesting access point comprising:
memory storing instructions;
at least one processor coupled to the memory, wherein the instructions, when executed by the at least one processor, individually or collectively, cause the requesting access point to perform operations, the operations comprising:
transmitting a Co-RTWT negotiation request message including information about restricted target wake time (RTWT) schedule protection level indicating at least one of coordinated beamforming (Co-BF) or coordinated spatial reuse (Co-SR) is usable for a RTWT schedule, to one or more coordinated access points;
receiving a Co-RTWT negotiation response message including an indication of a selection of the Co-BF or the Co-SR based on the information about the RTWT schedule protection level; and
establishing a Co-RTWT agreement for the RTWT schedule based on the selected Co-BF or Co-SR.

16. The requesting access point of claim 15, wherein the information about the RTWT schedule protection level comprises a parameter configured to indicate a coordination mode that determines whether transmission by the one or more coordinated access points is permitted and how the transmission is performed during a protected service period of the RTWT schedule.

17. The requesting access point of claim 16, wherein the Co-RTWT negotiation request message comprises restricted target wake time station information identifying one or more stations associated with the RTWT schedule.

18. The requesting access point of claim 16, wherein establishing the Co-RTWT agreement comprises transmitting a message to initiate coordinated beamforming negotiation or coordinated spatial reuse negotiation based on the selected Co-BF or Co-SR.

19. The requesting access point of claim 16, wherein the operations further comprise:
including in the Co-RTWT negotiation request message a Co-BF scheme information set or a Co-SR scheme information set; and
associating the Co-BF or Co-SR with a restricted target wake time schedule identifier.

20. The requesting access point of claim 16, wherein the operations further comprise broadcasting an intra-basic service set announcement indicating the RTWT schedule and the selected Co-BF or Co-SR to its associated stations.
